(19) United States
(12) Patent Application Publication
(10) Pub. No.: US 2007/0218382 A1
(43) Pub. Date: Sep. 20, 2007

(54) TONER AND METHOD OF MANUFACTURING THE SAME

(76) Inventors: Shigeru Emoto, Numazu-shi (JP); Akinori Saitoh, Numazu-shi (JP); Naohiro Watanabe, Sunto-gun (JP); Masahide Yamada, Numazu-shi (JP); Masahiro Ohki, Numazu-shi (JP); Ryota Inoue, Mishima-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/687,060

(22) Filed: Mar. 16, 2007

(30) Foreign Application Priority Data
Mar. 17, 2006 (JP) 2006-073720

(51) Int. Cl. G03G 9/087

(52) U.S. Cl. 430/108.1; 430/110.1; 430/109.4; 430/137.1; 430/108.7

(57) ABSTRACT

A toner containing a toner particle containing a binder resin, a colorant, a releasing agent and a laminar inorganic mineral in which part or all ions present between layers are modified by organic ions. The toner particle has a structure such that when the particle is heated at a temperature ranging from 65 to 90° C. the releasing agent is melted on the outside of the toner particle to form a particle having a sea-island structure.

### BACKGROUND OF THE INVENTION

1. Field of the Invention

The present invention relates to a toner and a method of manufacturing the toner.

2. Discussion of the Background

In a contact pressure and heating method by a heating roller in the electrophotography, a toner image is fixed such that the surface of a heating roller having a releasing property to a toner is brought into contact with the toner image on a recording medium upon application of heat and pressure while the recording medium passes the heating roller. This method is extremely thermally efficient so that a toner image is quickly fixed since the toner image is melted and fixed on a recording medium while the surface of the heating roller is contacted with the toner image under pressure.

However, in this contact pressure and heating method, the surface of a heating roller and a toner image are contacted in a melting state of toner upon application of pressure. Part of the toner image can be transferred and attached to the surface of the fixing roller. Then, the attached toner can be retransferred to the next recording medium so that the next recording medium can be contaminated, namely offset phenomenon occurs. Fixing and hot offset vary depending on the fixing method and are normally related to the fixing speed. High speed fixing involves relatively large problems about toner.

In a high speed fixing, a toner having a relatively low melting viscosity is used in comparison with the case of a low speed fixing. The surface temperature of a heating roller is lowered and the fixing pressure is reduced to prevent high temperature offset and winding offset which occur during fixing of a toner image. However, when a toner having such a low viscosity is used for a low speed fixing, offset phenomena easily occur at a high temperature.

Considering this situation, a toner has been demanded which has a large fixing temperature area with an excellent anti-offset property to deal with from a high end apparatus to a low end apparatus.

With regard to toner, toner has been reduced in size to improve image definition and vividness of images. However, the fixing property of such a toner in a halftone portion formed thereof deteriorates. These are significant phenomena in the case of high speed fixing. This is because the amount of toner is small in a half tone portion, the toner transferred to concave portions on a recording medium receives a small amount of heat from a hearing roller and the fixing pressure to the concave portions is restrained by convex portions. The toner transferred to concave portions in a half tone portion of a recording medium has a thin layer thickness and tends to receive a relatively large shearing force per toner particle in comparison with toner particles in a solid image portion at which a thick layer is formed. Thus, offset phenomenon easily occurs, resulting in poor quality of a resultant fixing image.

Toner is desired to have a small particle diameter with a narrow particle size distribution in terms of a good combination of fixing performance, anti-hot offset property and quality images. Furthermore, to improve transferability, toner form is desired to be spherical but toner having an irregular form has a wide applicability to an apparatus taking a blade cleaning method. Not only fixing property, image performance and cleaning performance but also preservability and a charging property are desired to be satisfied simultaneously at a high level. Variety of intensive studies have been made with a main focus on binder resins to meet these requirements.

As an economical method of obtaining a dry toner having such desired characteristics, a mixing, kneading and pulverizing method and a polymerization method have been put into practice. To obtain vivid images and speed up the fixing speed as mentioned above with good cleanability, it is desired to reduce toner in size with a narrow particle size distribution and have an irregular form. In addition, a binder resin is desired to be selected taking into consideration fixing performance. In addition, toner is preferred to be manufactured in an economical manner satisfying such performances and properties. Published unexamined Japanese patent applications Nos. (hereinafter referred to as JOP) H11-149180 and 2000-292981 describe a toner containing a toner binder and a colorant, which is prepared by an elongation reaction and/or cross-linking reaction of a polyester prepolymer having isocyanatge groups in an aqueous medium by amines and the manufacturing method of the toner as a method of obtaining toner having a good combination of performance and economical production system.

JOPs H11-149180 and 2000-292981 describe toner manufacturing methods relating to granulation in aqueous medium. When toner is granulated in an aqueous medium, pigments in oil phase having a small droplet form agglomerate at the interface between the oil phase and the aqueous phase, which causes decrease in volume resistance and non-uniform dispersion of the pigments. Thus, the obtained toner has basic performance problems. Without targeted forms and characteristics, it is difficult to obtain oilless toner having a small particle diameter with suitably controlled forms and apply the toner to an apparatus. Each JOP does not include descriptions of methods of making irregular formed toner, which leaves the problems about blade cleaning unsolved. Pigments in toner particles granulated in an aqueous medium tend to be located on the surface of the toner particles and in addition the oleophilic component in an aqueous medium is easily attracted to the surface of the toner particle. When such a toner has an excessively small particle diameter, for example, 6 μm, the specific surface area of the toner particle tends to be large. In this case, polymer design and particle surface design are key to obtain desired charging characteristics and fixing characteristics but there is no specific method of achieving a good fixing performance.

JOP 2004-054204 describes a chemical toner using a prepolymer containing isocyanate groups which is good at improving technology on fixing property and hot offset property. However, a charge controlling agent is fixed on the surface of the toner particle to secure the charging performance, which has an adverse impact on fixing property. To control a spindle form of the toner, shearing force due to stirring is provided in addition to the adjustment time of removing a solvent. However, generally, particles manufactured from oil phase containing a solvent tend to be spherical so that it is extremely difficult to form a particle having an irregular shape.

In recent years, image quality having a high representation and accuracy has been demanded. This demand is increasing not only in monochrome but also in full color. Especially, a full color toner image tends to have half tone portions. Thus, with a high representation and accuracy, a smooth color image can be obtained with a large variety of color representations. Therefore, toner having a small particle diameter and/or spherical form has been developed.

JOPs 2002-148863, H05-313416 and H02-148046 describe a method of manufacturing a toner containing a binder resin and a colorant. The method contains a process of dispersing mother toner particles in water or an aqueous medium containing a dispersing agent to form a dispersion system, a process of making the mother toner particle absorbing a softening agent by pouring into the dispersion system a liquid mixture of the softening agent and an organic solvent which is soluble in the water or the aqueous medium and dissolves the softening agent, and a process of removing the softening agent from the mother toner particle. Thus, the toner can have a spherical form regardless of the kind of resin component contained in the toner and without having an adverse impact on the particle size distribution of the mother toner particles.

However, the spherical toner described in JOPs 2002-148863, H05-313416 and H02-148046 tends to roll on an image bearing member so that the toner easily slips into between the image bearing member and a cleaning blade when a blade cleaning system is adopted, resulting in poor cleaning performance. In addition, this easily causes a problem that dust gathers around toner dots in the developing process and the transfer process.

Also, the chemical toner, which is prepared by granulating particles in an aqueous medium, tends to have a spherical form due to the interface tension of droplets produced during the dispersion process. Spherical toner has a good fluidity even when the toner has a small particle diameter. Thus, such a toner is advantageous to hopper design and developing unit design in that torque for rotating a developing roll can be reduced. However, such a toner is selective in light of a cleaning system. Namely, the surface of an image bearing member after a toner image is transferred is cleaned by a blade, a fur brush, a magnetic brush, etc. Among these, blades are widely used because of their simple structure and good cleanability. However, spherical toner rolls between an image bearing member and a cleaning blade and slips into therebetween. This is a large problem for a cleaning blade system.

Several methods have been made to apply such a chemical toner to the blade cleaning system. For example, JOP H02-51164 describes a method of manufacturing a toner in which a resin solution containing a polyester resin and an organic solvent is emulsified in an aqueous medium, the organic solvent is removed to form resin particulates and the resin particulates are agglomerated to prepare toner particles. However, there is no description for making toner particles have an irregular form so that the toner particles tend to be spherical. JOP 2002-351139 describes a polymerized toner by suspension polymerization. Basically, the polymerized toner is that irregular formed aggregates having a particle size of from 5 to 25 μm are formed by aggregating fine primary particles having a particle size not greater than 10 μm and pigments are dispersed in the primary particles. However, this toner is made of styrene-acryl materials so that there is a limit to improving the fixing property of the toner.

### SUMMARY OF THE INVENTION

Because of these reasons, the present inventors recognize that a need exists for a toner having an irregular shape and a good low temperature fixing property to produce quality images with high definition regardless of cleaning systems, including a blade cleaning system, while keeping advantageous points as a chemical toner, for example, a narrow particle size distribution, reduction in size and excellent fluidity and also for a method of manufacturing the toner.

Accordingly, an object of the present invention is to provide a toner having an irregular shape and a good low temperature fixing property to produce quality images with high definition regardless of cleaning systems, including a blade cleaning system, while keeping advantageous points as a chemical toner, for example, a narrow particle size distribution, reduction in size and excellent fluidity.

Briefly these objects and other objects of the present invention as hereinafter described will become more readily apparent and can be attained, either individually or in combination thereof, by a toner containing a toner particle containing a binder resin, a colorant, a releasing agent and a laminar inorganic mineral in which part or entire of ions present between layers are modified by organic ions. The toner is prepared by a method including dispersing or emulsifying a toner constituent liquid mixture containing the colorant, the binder resin and/or a precursor of the binder resin, the releasing agent and the laminar inorganic mineral, in an aqueous medium containing water to obtain a liquid dispersion or an emulsion, and removing the organic solvent and water from the liquid dispersion or the emulsion, and the toner particle has a structure such that when the particle is heated at a temperature ranging from 65 to 90° C. the releasing agent is melted on the outside of the toner particle to form a colored particle having a sea-island structure.

It is preferred that the volume average particle diameter of the toner is from 3 to 6 μm, the ratio (Dv/Dn) of the volume average particle diameter (Dv) to the number average particle diameter (Dn) it from 1.00 to 1.30, and the binder resin has a glass transition temperature (Tg) of from 40 to 55° C. and the weight average particle diameter (Mw) of from 3,000 to 6,500.

It is still further preferred that, in the toner mentioned above, the toner constituent liquid mixture further contains the binder resin further containing a polyester prepolymer containing at least one isocyanate group and a compound for conducting an elongation reaction or cross-linking reaction with the prepolymer and the method further includes conducting a cross-linking or elongation reaction in the toner constituent liquid mixture in the aqueous medium.

It is still further preferred that, in the toner mentioned above, the ratio of the releasing agent having a dispersion particle diameter of from 0.3 to 1.0 μm is not greater than 70% by number in the toner particle.

It is still further preferred that, in the toner mentioned above, the toner constituent liquid mixture has a Casson yield value of from 1 to 10 Pa at 25° C. and a non-Newtonian index tan θ of from 0.75 to 0.95 at 25° C. and the toner has a form factor SF-1 of from 140 to 200.

As another aspect of the present invention, a method of manufacturing a toner particle is provided which includes dispersing or emulsifying a toner constituent liquid mixture containing an organic solvent, a colorant, the binder resin and/or a precursor thereof, a releasing agent and a laminar inorganic mineral in which part or all ions present between layers therein are modified by organic ions, in an aqueous medium comprising water to obtain a liquid dispersion or an emulsion; and removing the organic solvent and water from the liquid dispersion or the emulsion. The method produces a toner particle having a structure such that when the particle is heated at a temperature ranging from 65 to 90° C. the releasing agent is melted on the outside of the toner particle to form a colored particle having a sea-island structure.

It is preferred that, in the method mentioned above, the toner constituent liquid mixture has a non-Newtonian index tan θ of from 0.75 to 0.95 at 25° C.

It is still further preferred that, in the method mentioned above, the toner constituent liquid mixture has a Casson yield value of from 1 to 10 Pa at 25° C. and the toner particle has a form factor SF-1 of from 140 to 200.

As another aspect of the present invention, a developing agent is provided which contains the toner mentioned above and a carrier.

As another aspect of the present invention, an image forming apparatus is provided which includes an image bearing member for bearing a latent image thereon, a charging device for charging the image bearing member, a developing device for developing the latent image containing the toner mentioned above, a transfer device for transferring the latent image to a transfer body, a discharging device for discharging the image bearing member and a cleaning device for cleaning the surface of the image bearing member.

As another aspect of the present invention, an image forming apparatus is provided which includes charging an image bearing member by a charging device, irradiating the image bearing member by an irradiating device to form a latent electrostatic image thereon, developing the latent electrostatic image on the image bearing member with the toner mentioned above, removing residual toner remaining on the image bearing member by a cleaning device and transferring the toner image to a transfer body.

As another aspect of the present invention, a toner container is provided which includes a container and the toner mentioned above therein.

As another aspect of the present invention, a process cartridge is provided which includes an image bearing member for bearing a latent electrostatic image, a developing device for developing the latent electrostatic image containing the toner mentioned above and optionally at least one of a cleaning device, a transfer device, an irradiating device and a charging device.

These and other objects, features and advantages of the present invention will become apparent upon consideration of the following description of the preferred embodiments of the present invention taken in conjunction with the accompanying drawings.

### BRIEF DESCRIPTION OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a diagram illustrating an example of the form of the toner of the present invention;

FIG. 2 is a diagram illustrating a sea-island structure of a colored particle;

FIG. 3 is a diagram illustrating an example of a process cartridge for use in the present invention; and

FIG. 4 is a graph illustrating a flow curve based on rising temperature method.

### DETAILED DESCRIPTION OF THE INVENTION

Generally, the present invention provides a toner which is prepared by dispersing and/or emulsifying an oil phase (toner constituent liquid mixture containing an organic solvent containing a binder resin, a colorant (e.g., pigment), a releasing agent (e.g., wax) and a modified laminar inorganic mineral in an aqueous medium and removing the solvent from the obtained liquid dispersion and liquid emulsion. The toner particle contains a dispersion body containing the wax, the binder resin, the pigment and the laminar inorganic mineral. The wax is dispersed existing relatively near the surface of the toner particle and melts outside to form a sea-island structure of a colored particle in a heating test having a heating and cooling unit in the range of 65 to 90° C.

The toner of the present invention is excellent in the releasing property and the low temperature fixing property due to oozing of a releasing agent (wax) and a binder resin and has a good cleanability, for example, in a blade cleaning system, with a small amount of transfer remaining toner due to its irregular form so that quality images can be obtained. Furthermore, the laminar inorganic mineral dispersing in the toner imparts the toner particle with a good charging ability and a good agglomeration property of the oil phase during emulsification to assist forming an irregular form of the toner particle.

The toner of the present invention described above will be described below in detail with reference to several embodiments and accompanying drawings.

In the toner particle, the releasing agent is present on the utmost surface, and organic resin particulates are present outside the utmost surface. The toner can have a spindle form and/or a dimple form with a preferred volume average particle diameter of from 4.0 to 6.0 μm and form factor SF-1 of the toner preferably ranging from 140 to 200.

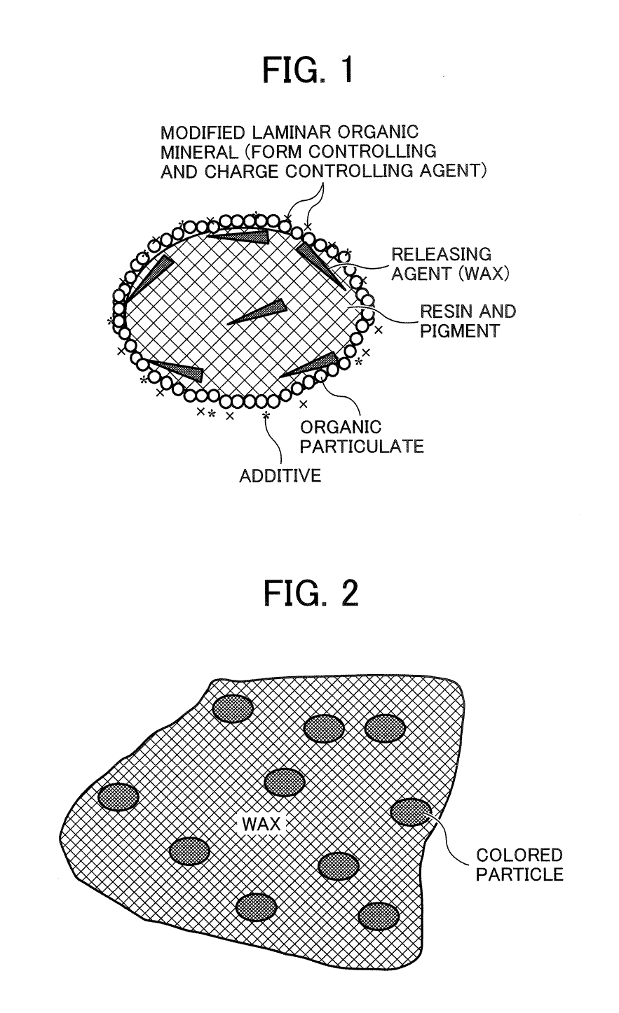

FIG. 1 illustrates the structure of a toner particle. The structure is that pigments are dispersed in a resin, which is a main component, and wax is dispersed in all over the toner particle and significantly localized near the surface of the toner particle. The toner particle is covered with organic particulates and modified laminar inorganic minerals (e.g., organically modified montmorillonite) are existent on the surface layer. Further, additives are fixedly attached to the uppermost layer of the toner particle. FIG. 2 is a conceptual diagram illustrating a status (i.e., the sea-island structure) of a colored particle in the heating test mentioned above.

Toner Structure, Toner Characteristics and Toner Quality

The inventors of the present invention made an intensive study on the fixing property, the hot offset property, the image quality, the high temperature preservation property, the charging property and the cleaning property and have thus obtained a toner having a particle structure achieving a good combination of these properties. The toner contains particles formed by an elongation reaction and/or a cross-linking reaction of amines in an aqueous medium. In the toner particle, pigments and modified laminar inorganic minerals dispersed by a non-modified and/or modified polyester having a low glass transition temperature and a low molecular weight are contained and a wax having a high releasing property is present around the surface layer. By covering the surface of the toner particle with the releasing agent (wax) and organic particulates, the toner particle can have a high charging ability desired during development and transfer of toner. Furthermore, a low temperature softening polymer inside the particle rapidly oozes during fixing by a heating roller system so that the toner can have a good fixing property. In addition, the wax having a high releasing property which is dispersed near the surface of the toner particle oozes sooner than the binder does to secure the releasing property of the heating roller. Additionally, since the binder having a low softening point prevents blocking caused by heat, a good combination of preservability and charging property can be obtained by forming a thin layer of organic particulates on the surface of toner particles and dispersing the modified laminar inorganic mineral functioning as a charge controlling agent material in the particle.

The status, i.e., dissolution and dispersion status of pigment, binder resin and wax component, exhibiting the function of such a particle, can be clearly seen by the following method in which the heating and cooling state of the particle is observed with a cooling and heating unit (manufactured by JAPAN HIGH TECH CO., LTD.) for a microscope.

Observing Method of Heating and Cooling Unit for Microscope

Optical microscope (or another kind of microscope), manufactured by Olympus Corporation: magnification power: 20× and 40×.

Heating and cooling unit for microscope (manufactured by JAPAN HIGH TECH CO., LTD.): rising rate of toner temperature: 5° C./min.

Temperature range: 40 to 120° C.

Monitor (connected with the unit for observing the status in which toner particles are softened)

The heating and cooling unit is connected to the microscope so that the melting status of toner particles can be observed.

Toner sample is set on a glass and a glass cover is placed on the sample. The sample is heated at the rate mentioned above.

The temperature at which the wax melted out to form a sea-island structure and the temperature at which the toner particle is melted out are measured.

Laminar Inorganic Mineral

Rheology Additives

A laminar inorganic mineral is preferred which can be dissolved and/or dispersed in an organic solvent and can impart oil phase rheology effect when the laminar inorganic mineral is dispersed in a binder pigment liquid dispersion.

Specific examples of the laminar inorganic mineral include montmorillonite, bentonite, hectorite, attapulgite, sepiolite and mixtures thereof. Among these, montmorillonite and bentonite are preferred since these do not affect toner characteristics, it is easy to adjust the viscosity, and the addition amount thereof can be small.

Marketed products as rheology additives include, for example, Quaternium 18 Bentonites, e.g., BENTONE 3, BENTONE 38, BENTONE 38V (manufactured by Elementis Specialties, Inc.), TIXOGEL VP (manufactured by United Catalyst Corporation), CLAYTONE 34, CLAYTONE 40, and CLAYTONE XL (manufactured by Southern Clay Inc.); Stearal conium BENTONITE, e.g., BENTONITE 27 (manufactured by Elementis Specialties, Inc.), TIXOGEL LG (manufactured by United Catalyst Corporation), and CLAYTONE A and CLAYTONE APA (manufactured by Southern Clay Inc.); and QUATANIUM 18/BENZACONIUM BENZONITE.

In the present invention, toner forms can be easily made irregular by using a laminar inorganic mineral at least some of which is modified by organic ions.

The laminar inorganic mineral has a high hydrophilic property due to its layered structure. When a laminar inorganic mineral is used without modification for a toner which is granulated by dispersion in an aqueous medium, the laminar inorganic mineral is transferred into the aqueous medium so that it is difficult to make the toner have an irregular form. By at least partially modifying a laminar inorganic mineral with an organic ion, the laminar inorganic mineral can have a suitable hydrophobic property. Thus, the oil phase containing a toner component and/or a precursor thereof can have a non-Newtonian viscosity and the toner particles can have an irregular form.

The content of a laminar inorganic mineral at least partially modified by an organic anion is preferably from 0.05 to 5′ by weight based on the toner material.

Specific examples of the laminar inorganic mineral at least some of which is modified by an organic ion include montmorillonite, bentonite, hectorite, attapulgite, sepiolite and mixtures thereof. Among these, montmorillonite and bentonite are preferred since these do not affect toner characteristics, it is easy to adjust the viscosity, and the addition amount thereof can be small.

Marketed products of laminar inorganic minerals at least some of which is modified by an organic ion include, for example, Quaternium 18 Bentonites, e.g., BENTONE 3, BENTONE 38, BENTONE 38V (manufactured by Elementis Specialties, Inc.), TIXOGEL VP (manufactured by United Catalyst Corporation), CLAYTONE 34, CLAYTONE 40, and CLAYTONE XL (manufactured by Southern Clay Inc.); Stearal conium BENTONITE, e.g., BENTONITE 27 (manufactured by Elementis Specialties, Inc.), TIXOGEL LG (manufactured by United Catalyst Corporation), and CLAYTONE A and CLAYTONE APA (manufactured by Southern Clay Inc.); and QUATANIUM 18/BENZACONIUM BENZONITE. Among these, CLAYTONE AF and CLAYTONE APA are preferred.

A modified laminar inorganic mineral can be finely dispersed in a binder resin beforehand to make the modified laminar inorganic mineral finely disperse on the surface of toner particle. Thus, the modified laminar inorganic mineral is finely dispersed in a toner and is fixed around the uppermost surface of toner particles during emulsification. This is considered to be because the modified laminar inorganic mineral in an oil phase has a hydrophilic tendency during emulsification. A pigment master batch method is used to make a modified laminar inorganic mineral finely disperse in a binder resin.

Master batch pigments, which are prepared by combining a colorant with a resin, can be used as the colorant of the toner composition of the present invention. Specific examples of the resins for use in the master batch pigments or for use in combination with master batch pigments include the modified and unmodified polyester resins mentioned above; styrene polymers and substituted styrene polymers such as polystyrene, poly-p-chlorostyrene and polyvinyltoluene; styrene copolymers such as styrene-p-chlorostyrene copolymers, styrene-propylene copolymers, styrene-vinyltoluene copolymers, styrene-vinylnaphthalene copolymers, styrene-methyl acrylate copolymers, styrene-ethyl acrylate copolymers, styrene-butyl acrylate copolymers, styrene-octyl acrylate copolymers, styrene-methyl methacrylate copolymers, styrene-ethyl methacrylate copolymers, styrene-butyl methacrylate copolymers, styrene-methyl α-chloromethacrylate copolymers, styrene-acrylonitrile copolymers, styrene-vinyl methyl ketone copolymers, styrene-butadiene copolymers, styrene-isoprene copolymers, styrene-acrylonitrile-indene copolymers, styrene-maleic acid copolymers and styrene-maleic acid ester copolymers; and other resins, for example, polymethyl methacrylate, polybutyl methacrylate, polyvinyl chloride, polyvinyl acetate, polyethylene, polypropylene, polyesters, epoxy resins, epoxy polyol resins, polyurethane resins, polyamide resins, polyvinyl butyral resins, acrylic resins, rosin, modified rosins, terpene resins, aliphatic or alicyclic hydrocarbon resins, aromatic petroleum resins, etc. These resins can be used alone or in combination.

The master batch mentioned above is typically prepared by mixing and kneading a resin and a colorant upon application of high shear stress thereto. In this case, an organic solvent can be used to boost the interaction of the colorant with the resin. In addition, flushing methods in which an aqueous paste including a colorant is mixed with a resin solution of an organic solvent to transfer the colorant to the resin solution and then the aqueous liquid and organic solvent are separated to be removed can be preferably used because the resultant wet cake of the colorant can be used as it is. In this case, three-roll mills can be preferably used for kneading the mixture upon application of high shear stress thereto.

Toner Particle Size Distribution

A toner that has a small volume average particle diameter (DV) can improve the fine line reproduction property. Preferably, the volume average particle diameter is not greater than 6 μm. However, a toner that has an excessively small volume average particle diameter may cause deterioration of cleaning property so that the volume average particle diameter is preferably not smaller than 3 μm. When the ratio of toner particles having a volume average particle diameter less than 3 μm is greater than, for example, 20%, the number of toner particles having a fine particle diameter, which is not easy to be developed on magnetic carriers or the surface of a developing roller, increases so that abrasive contact between the toner particles, magnetic carriers and/or the developing roller are not sufficient. As a result, the number of reversely charged toner particles increases, which may cause background fouling and lead to deterioration of image quality.

The particle diameter distribution represented by the ratio (Dv/Dn) of the volume average particle diameter (DV) to the number average particle diameter (Dn) is preferably from 1.00 to 1.30. When a particle diameter distribution is sharp, the amount of charge in toner is uniform and the background fouling can be restrained. When Dv/Dn is too great, it is difficult to obtain high definition images since the charge amount distribution is wide. The particle diameter of a toner can be measured by using Coulter Counter Multisizer (manufactured by Beckman Coulter Inc.). The average particle diameter is obtained by measuring 50,000 toner particles with 50 μm aperture corresponding to the particle diameter of the toner.

The toner of the present invention can produce high definition and high quality images with an excellent low temperature fixing property and an excellent hot offset property to minimize the power consumption. Namely, to address to the demand for improving a releasing property of a toner, the toner is made to have an irregular form, for example, a spindle form and a dimple form, and wax is controlled to be present near the surface of the toner particle. Thus, the toner can satisfy both of the production of high definition and high quality images and an excellent fixing property. The amount of wax present near the surface of the toner measured by FTATR-IR (Fourier Transform Attenuated Total Reflection—Infrared Spectroscopy) is from 2 to 10% by weight based on all the component in the toner. The volume average particle diameter (DV) of the toner is from 3.0 to 6.0 μm. The form factor SF-1 of the toner is from 140 to 200. These contributes to improvement on cleaning property. An SF-1 of from 140 to 160 is particularly preferred. When SF-1 is too large, a toner particle tends to crack, which leads to quality deterioration due to fine particles. When SF-1 is too small, the cleaning property tends to deteriorate.

Form Factor SF-1 and Testing Method

Form Factor SF-1 of toner is defined by the following relationship (1) and used as the coefficient indicating the toner form, etc., with the relationship (2), which is shown for reference below. These are based on a statistical approach of image analysis by which image area, length and form observed by an optical microscope, etc., can be quantity-analyzed with high accuracy. For example, a certain number (between about 100 and about 300) of projection images of toner particles enlarged to the magnification power of 1,000× by a high resolution scanning type electron microscope S-2700 (manufactured by Hitachi, Ltd.) are selected at randomly for sampling. The images are guided to LUSEX III via an interface for statistical treatment and calculation.
SF-1=(MXLG)²/AREA×π/4×100 (1)
SF-2=(PERI)²/AREA×¼π×100 (2)

In the relationships (1) and (2), MXLG, AREA and PERI represent the maximum particle diameter (major axis) of the projected image of a measured toner particle, the area thereof, and the circumstance thereof, respectively, as shown in FIG. 1.

As seen in the relationship (1), the form factor SF-1 is obtained by: multiplying the maximum particle diameter of a toner particle to the power of 2; dividing the resultant by the projected area of the toner particle; multiply π/4 with the resultant; and multiply 100 with the resultant. A toner particle having an SF-1 that is close to 100 has a form close to a spherical form. A toner particle having a spindle form, i.e., away from a spherical form, has a large value, away from 100. Namely, the form factor SF-1 represents the degree of roundness of a toner particle and is related to transfer efficiency in the transfer process and the amount of toner remaining on an image bearing member.

In the present invention, the amount of wax present near the surface of a toner particle based on all the components in the toner particle is dependent on the average dispersion particle diameter of the wax and is suitably from 2 to 10% by weight. When this amount is too small, a desired anti-hot offset property is not obtained. When the amount is too large, the developing property and the transfer property may deteriorate and the filming on an image bearing member and a charge imparting member is significant, which are not preferred.

“near the surface” represents the range between the surface and 0.3 μm therefrom in depth, which can be measured by a wavelength of 2,850 cm⁻¹ of Attenuated Total Reflection—Infrared Spectroscopy (ATR-IR).

WAX Dispersion Particle Diameter Measurement by TEM

In the present invention, the maximum particle diameter of wax is determined as wax dispersion particle diameter. Specifically, toner is embedded in an epoxy resin and sliced to obtain super thin pieces (about 100 nm thickness). Subsequent to dye by ruthenium tetroxide, the dyed sliced pieces are observed by a transmission electron microscope (TEM) at a magnification power of from 10,000 to 50,000 and photographed. The photographs are image-evaluated to observe the dispersion status of the wax, and the dispersion particle diameter is measured.

In the present invention, the existing ratio of wax exposed to the surface of a toner particle can be measured by Fourier Transform Attenuated Total Reflection—Infrared Spectroscopy (FTATR-IR).

FTATR-IR method is; to irradiate a sample attached to ATR crystal with infrared to detect all the reflection component (the amount of wax contained in the range of from about 0.2 to about 0.5 μm in depth from the surface of a toner particle can be detected); to make analytical curve of the amount of wax in the toner particle by FTIR in advance; to make relative analytical curve by ATR method; and to calculate the amount of wax from the relative analytical curve of the absorption wavelength of the wax and the absorption wavelength of a resin.

Wax for use in the toner of the present invention preferably has a low melting point, for example, of from 65 to 80° C., to effectively function as a releasing agent for the toner. It is found that the wax in the toner starts melting at around 65° C. and oozes to form a sea-island status in which the wax is sea and pigment particles are islands when the toner is observed with a heating and cooling device (manufactured by Japan High Tech Co., Ltd.). High temperature offset can be prevented by using a toner in this status without applying a releasing agent, for example, oil. Wax in such a toner oozes relatively quickly in comparison with the case of a typical toner. In addition, since a binder resin and a modified laminar inorganic mineral are fixed on the outer side of a toner particle of the toner, protective materials (i.e., resin particulates) present at outer side protect the binder resin having a low melting point and wax having a low softening point located on the inner side of the toner particle in summer time (temperature from about 30 to 50° C.).

The temperature observation range of from 65 to 90° C. in which the sea-island structure of wax and resin dispersion particulate is formed by a heating and cooling device is an optimal range for having a good combination of low temperature fixing property and anti-hot offset property. When the temperature is too low, wax tends to melt soon so that the fixing property deteriorates to the contrary. When the temperature is too high, wax tends to start melting late so that the anti-hot offset property deteriorates.

The melting point of wax for use in the present invention is determined as the maximum endotherm peak by a differential scanning calorimeter (DSC)

The melting point ranging from 65 to 80° C. of wax components functioning as the releasing agent for use in the present invention is a temperature range for a good anti-hot offset property by the heating and cooling device.

Specific examples of such waxes include vegetable waxes, for example, candelilla wax (melting point: 78° C.), rice wax (melting point: 80° C.), mineral waxes, for example, ozocerite (melting point: 72° C.), paraffin wax (melting point: 65 to 75° C.), and microcrystalline wax. Synthesized waxes can be also used. Specific examples thereof include synthesized hydrocarbon waxes, ester waxes, ketone waxes, and ether waxes having a melting point of from 65 to 80° C. with a high releasing property. Furthermore, crystalline polymer materials can be used. Among these, paraffin wax is preferred.

A wax dispersing agent is used such that wax is made to be present near the surface of a toner particle. As the wax dispersing agent, there can be used a monomer for a toner binder resin which is hardly affiliatve with water during emulsification of a toner and the polymerization reaction product of which is non-compatible or hardly compatible with wax. Such a wax dispersing agent is added in an amount of from 20 to 1000 based on a wax and dispersed and polymerized so that the wax can be controlled to be positioned near the surface of a toner particle. When the content of such a wax dispersing agent is too small, wax may not be contained in a toner particle. When the content of such a wax dispersing agent is too large, wax dispersion is not sufficient or wax tends to be positioned on the inner side of a toner particle so that the wax may ooze late and the effect of the wax is reduced.

Monomers for use in a typical toner binder resin can be used as the binder resin which hardly affiliates with water.

Specific examples thereof include styrene based monomers (e.g., styrene, α-methyl styrene, p-methyl styrene, m-methyl styrene, p-methoxy styrene, p-hydroxy styrene, p-acetoxy styrene, vinyl toluene, ethyl styrene, phenyl styrene and benzyl styrene), unsaturated carboxyl acid alkyl ester (having 1 to 18 carbon atoms) (e.g., methyl(meth)acrylate, ethyl(meth)acrylate, buthyl(meth)acrylate, and 2-ethylhexyl(meth)acrylate), vinyl ester based monomers (e.g., vinyl acetate), vinyl ether based monomer (e.g., vinyl methyl ether), halogenated vinyl based monomers 8e.g., vinyl chloride), dien based monomers (e.g., butadiene and isobuthylene), unsaturated nitrile based monomers (e.g., acrylnitrile and cyanostyrene) and mixtures thereof.

Among these, styrene based monomers, unsaturated carboxylic acid alkyl esters, (meth)acylic acid alkyl esters and mixtures thereof are preferred. Styrene, and a mixture of styrene, (meth)acrylic acid alkyl esters and (meth)acrylonitrile are particularly preferred.

It is deduced that effective fixing on paper by roller fixing and belt fixing starts at a temperature around 70 to 100° C. at a photocopier, a printer and a facsimile machine considering the saving energy technology of late used therein. To melt a toner, the toner is desired to be fluidized at a temperature around that range. Therefore, the toner is desired to start softening at a temperature between about 90 to 110° C. for fixing.

However, to make a toner softened at 90° C., the glass transition temperature (Tg) of the toner is not higher than 50° C. The glass transition temperature of such a polymer depends on its molecular weight.

When the glass transition temperature is 50° C. or lower, the fixing property tends to be improved but the preservability may deteriorate.

In the toner of the present invention, Tg of the toner is designed by a binder having an extremely low Tg of from 40 to 55° C. and polymer particulates having a glass transition temperature of from 50 to 110° C. are present on the surface layer of the toner particle in an amount of from 0.3 to 2.5% based on the toner particle. As shown in FIG. 1, the particles uniformly covering the toner particle protect the binder resin having a low softening point from heat such that the particles function as an encapsulating particle. The reason of having a good combination of the anti-hot offset, the low temperature fixing property and the high temperature preservability is that the binder resin on the surface of a toner particle has a large molecular weight through urea linkage formed as the reaction result of prepolymers and amines and part of the surface is mesh-structured to form a three dimension structure relatively strong for stress. Furthermore, while a material having the same thermal characteristics as a typical toner is used on the surface of a toner particle, a polyester resin, which has a low glass transition temperature, is used in the inner side of the toner particle. Therefore, such a toner has a particle structure advantageous for having a good low temperature fixing property in comparison with a homogeneous toner particle prepared by kneading and pulverization. Polymer particulates covering the surface of a toner particle are desired to quickly react to the heat from a heating roller during fixing to ooze toner particle binder resins outside of the surface layer. The balance between the high temperature preservability and oozing can be controlled by the content of the polymer particulate covering a toner particle. Polymer particulates remaining on a toner particle have a particle diameter of from 10 to 200 nm and the amount of the polymer particulates covering the toner particle is from 0.3 to 2′ by weight. A polymer particulate having an excessively small particle diameter, for example, 10 nm or less, is difficult to obtain. A polymer particulate having an excessively large particle diameter, for example, 200 nm or greater, remains thick on the surface layer of a toner particle, resulting in deterioration of the fixing property. With regard to Tg of a toner, the temperature range of from 40 to 55° C. is preferred in consideration of a good low temperature fixing property. When the glass transition temperature is too low, it is difficult to granulate toner. A glass transition temperature that is excessively high is not preferred to have a good low temperature fixing property.

A toner having a spherical form made by a wet polymerization has a low cleanability. Even a toner having an average particle diameter of about 10 μm is subject to poor cleaning performance for a blade cleaning system. This is because such a toner has a smooth surface so that the toner particle tends to roll on an image bearing member and easily slips into between a cleaning blade and the image bearing member. Since a spherical toner does not have a rough surface, all the external additives attached thereto contact the surface of an image bearing member. In addition, since a large amount of external additives, for example, silica, is attached to a spherical toner, such external additives are embedded into an image bearing member and attract toner thereto, resulting in streaks on an image. On the other hand, toner having an irregular form has a rough surface and does not roll on an image bearing member before a cleaning blade. Therefore, it is easy to remove remaining toner. For example, a toner having a spindle form has a limited number of rotation axes around which toner easily rolls on an image bearing member in comparison with a spherical toner. In the case of a toner having a flat form, such rotation can be further limited.

In addition, in an electrostatic transfer system, a toner having a spherical form on an image bearing member has a smooth surface and a good powder fluidity. Furthermore, since the attraction force between toner particles or toner particles and an image bearing member is small, such toner particles are easily subject to electric force line and are transferred truly along the electric force line so that the transfer rate is high. However, when a recording medium is detached from an image bearing member, a high electric field is generated (i.e., burst phenomenon) between the image bearing member and the recording medium, which makes toner dust gather on the recording medium. A toner having a spherical form, which is easily affected by electric force line, produces a large amount of toner dust, resulting in degradation of image quality.

In contrast, a toner having an irregular form or a flat form is hardly affected by the electric force line and hardly transferred therealong. Namely, the transfer rate is low. However, the attachment force between toner particles is large and toner dots transferred onto a recording medium are not easily cracked by an external force so that the generation of toner dust caused by burst phenomenon can be restrained.

A toner having a spindle form has a smooth surface with a suitable fluidity, is succumbed to the electric force line and truly transferred therealong so that the transfer rate is high. Further, a toner particle having a spindle form has a limited number of rotation axes around which the toner particle easily rolls. Therefore, toner particles do not easily scatter from toner dots on a recording medium by the burst phenomenon, resulting in quality images.

In an electrostatic development system, magnetic carriers or toner particles having a spherical form on a developing roller are easily influenced by the electric force line and truly developed along the electric force line of a latent electrostatic image. When reproducing fine latent image dots, fine line reproducibility is improved because such toner particles are easily positioned in a dense and uniform manner. However, in a contact development system, toner particles developed on an image bearing member are easily moved by abrasion against a magnetic brush or a developing roller, which may cause image quality deterioration due to dust.

Toner particles having an irregular form on a magnetic carrier or a developing roller do not have a good powder fluidity and the electric force line does not work on each toner particle smoothly. Thus, toner dots are not orderly positioned during development, which makes true development difficult, resulting in low fine line representation. This applies to toner particles having a flat form.

Toner particles having a spindle form have a suitable adjusted powder fluidity. Therefore, fine line reproducibility is good because the development is performed true to the electric force line of a latent electrostatic image. Toner particles developed on an image bearing member are not easily moved by abrasion against a magnetic brush or a developing roller, resulting in a visualized image without significant image deterioration caused by toner dust, etc.

In the toner of the present invention, to obtain toner particles having an irregular form with a good combination of charging ability, cleaning property, fixing property and anti-hot offset property in a balanced manner, viscous fluidity of a toner oil phase to be emulsified is desired to be restricted. A desired form of toner particles is obtained in a toner oil phase, when the viscous fluidity of the toner oil phase is that Casson yield value is from 1 to 25 Pa and non-Newtonian index tan θ is from 0.75 to 0.95 at 25° C. The toner oil phase is a solution or a liquid dispersion in which at least a prepolymer formed of a binder resin and modified polyester resin, a compound to conduct an elongation or cross-linking reaction with the prepolymer, a colorant, and a release agent are dissolved and/or dispersed in an organic solvent or an liquid emulsified dispersion in which only a non-modified polyester resin is used as a binder resin.

When Casson yield value is too small, a desired form is difficult to obtain. When Casson yield value is too large, it is difficult to control resultant forms.

It is desired to contain a modified laminar inorganic mineral in an amount of from 0.05 to 5% in the solid portion of the solution or liquid dispersion. When the content of a modified laminar inorganic mineral is too small, it is difficult to obtain a desired Casson yield value. An excessive content thereof may cause an adverse impact on the fixing property because the modified laminar inorganic mineral is fixed on the surface of a toner particle in an excessive amount.

Method of Yield Value and Tan θ

Casson yield value can be measured by using a high shear viscosity meter under the following conditions:

Device: AR2000 (manufactured by TA Instruments)

Shear stress: 120 Pa/5 min

Geometry: 40 mm steel plate

Geometry gap: 1 mm analysis software: TA DATA ANAYALYSIS (manufactured by Ta Instruments)

Yield value (stress yield value Pa): Extrapolation point of shearing speed S−=1 and S−=2 at S−=0 according to Casson flow equation. The range of shearing speed on measurement is from 0 to 300 s−

Tan θ: Flow curve of oil phase is measured. The condition: Gap is 0.5 mm at 25° C. The range of shearing speed on measurement is from 0 to 1,800 s− to 0 s−.

How to obtain tan θ: From Log-Log graph of the shearing speed s− and shearing stress. The range of shearing speed is from 0 to 2,000 s−.

The toner of the present invention preferably contains a material (hereinafter referred to as fixing material) which is fixed on the surface of the toner particle and makes the surface hydrophobic. As the fixing material, a mixture of silica and titanium oxide is preferred in terms of the charging ability and the fixing property. This is because the toner particle has a small particle diameter and does not have a good fluidity and in addition, polymer particulates cover the surface of the toner particle. As a result, the toner particle tends to combine with moisture in air so that the charging ability greatly fluctuates. In general, an inorganic material functioning as a fluidizing agent is added and mixed on the surface of a toner particle. The material covering the surface tends to reduce the fixing ability. However, when silica and titanium oxide are fixed on the surface, charging ability and fluidity can be secured and fixing property does not greatly deteriorate. This is considered to be ascribable to hydrophobization by silica and titanium oxide. In addition, boosting the amount of charges caused by reduction of the particle in size can be restrained by a combinational use of titanium oxide. A desired amount of charge is not obtained only by using titanium oxide.

These surface protective materials are fixed on the surface of a toner particle so that the materials are prevented from being detached from the surface. Thus, the materials are not attached to or damage carriers, a developing roller, an image bearing member, a contact type charging device, etc. These materials are fixed on the surface of a toner particle by using an external additive mixing device (or condition) having relatively a large mechanical stress in comparison with the case of a typical device.

In the present invention, a charge controlling agent can be fixed on the surface of a toner particle as a material to protect the surface before silica and titanium oxide are used. Thus, the surface of the toner can be abrasively charged and friction charging can be secured.

To fix these materials, mechanical or thermal treatment can be conducted in air. It is also possible to use electrochemical or mechanical treatment in a solvent in the middle of manufacturing by wet polymerization. For example, there is a method in which a toner and a protective material are mixed in a container by using a rotation body. In this method, in a container which does not have an extruding fixing portion from the inner wall of the container, a rotation body is rotated at a high speed to mix a toner and a protective material so that a toner on which the protective material is fixed can be obtained. There is another method in which a toner and a protective material are mixed beforehand. The mixture is sprayed with a hot air in a container by, for example, an atomizer to make the surface of the toner melted followed by rapid cooling. Thus, a toner to which the protective layer is attached is obtained. In a solvent, a protective material can be fixed by absorbing the protective material on the surface of a toner particle.

The content of silica which is attached to and fixed on the surface of the toner of the present invention is from 0.3 to 1.5%. The content of titanium oxide which is attached and fixed on the surface of the toner of the present invention is from 0.1 to 1.0%. When the content of both in total is too large, the fixing property tends to sharply deteriorate.

As the binder resin, a non-modified or modified polyester resin can be preferably used but the usable binder resins are not limited thereto.

The modified polyester represents a status in which a linking group other than ester linkage is existing in a polyester resin or a resin component having a different structure is bonded by, for example, ion-binding or covalent binding, in a polyester resin. Specifically, a functional group, for example, isocyanate group reactive with an acid group or a hydroxyl group, is introduced at the end of a polymer and the polymer conducts a reaction with a compound having an active hydrogen to modify the end.

Specific examples of modified polyesters (i) include a compound obtained from the reaction between polyester prepolymer (A) having an isocyanate group and amines (B). Specific examples of polyester prepolymers (A) having an isocyanate group include a resultant of the reaction between polyisocyanate (3) and a polyester, i.e., a polycondensation compound having an active hydrogen group which is prepared by polyol (1) and polycarboxylic acid (2).

Specific examples of the active hydrogen group contained in the polyesters mentioned above include hydroxyl groups (alcohol hydroxyl groups and phenol hydroxyl groups), amino groups, carboxylic groups, and mercarpto groups. Among these, alcohol hydroxyl groups are preferred.

Suitable polyols (1) include diols (1-1) and polyols (1-2) having three or more hydroxyl groups. It is preferred to use a (1-1) alone or mixtures in which a small amount of a (1-2) is mixed with a (1-1).

Specific examples of the diols (1-1) include alkylene glycol (e.g., ethylene glycol, 1,2-propylene glycol, 1,3-propylene glycol, 1,4-butanediol and 1,6-hexanediol); alkylene ether glycols (e.g., diethylene glycol, triethylene glycol, dipropylene glycol, polyethylene glycol, polypropylene glycol and polytetramethylene ether glycol); alicyclic diols (e.g., 1,4-cyclohexane dimethanol and hydrogenated bisphenol A); bisphenols (e.g., bisphenol A, bisphenol F and bisphenol S); adducts of the alicyclic diols mentioned above with an alkylene oxide (e.g., ethylene oxide, propylene oxide and butylene oxide); and adducts of the bisphenols mentioned above with an alkylene oxide (e.g., ethylene oxide, propylene oxide and butylene oxide); etc.

Among these compounds, alkylene glycols having from 2 to 12 carbon atoms and adducts of a bisphenol with an alkylene oxide are preferable. More preferably, adducts of a bisphenol with an alkylene oxide, or mixtures of an adduct of a bisphenol with an alkylene oxide and an alkylene glycol having from 2 to 12 carbon atoms are used.

Specific examples of the polyols (1-2) include aliphatic alcohols having three or more hydroxyl groups (e.g., glycerin, trimethylol ethane, trimethylol propane, pentaerythritol and sorbitol); polyphenols having three or more hydroxyl groups (trisphenol PA, phenol novolak and cresol novolak); adducts of the polyphenols mentioned above with an alkylene oxide; etc.

Suitable polycarboxylic acids (2) include dicarboxylic acids (2-1) and polycarboxylic acids (2-2) having three or more carboxyl groups. It is preferred to use dicarboxylic acids (2-1) alone or mixtures in which a small amount of a (2-2) is mixed with a (2-1).

Specific examples of the dicarboxylic acids (2-1) include alkylene dicarboxylic acids (e.g., succinic acid, adipic acid and sebacic acid); alkenylene dicarboxylic acids (e.g., maleic acid and fumaric acid); aromatic dicarboxylic acids (e.g., phthalic acid, isophthalic acid, terephthalic acid and naphthalene dicarboxylic acids; etc. Among these compounds, alkenylene dicarboxylic acids having from 4 to 20 carbon atoms and aromatic dicarboxylic acids having from 8 to 20 carbon atoms are preferably used.

Specific examples of the polycarboxylic acids (2-2) having three or more hydroxyl groups include aromatic polycarboxylic acids having from 9 to 20 carbon atoms (e.g., trimellitic acid and pyromellitic acid).

As the polycarboxylic acid (2-2), anhydrides or lower alkyl esters (e.g., methyl esters, ethyl esters or isopropyl esters) of the polycarboxylic acids mentioned above can be used for the reaction with a polyol.

Suitable mixing ratio (i.e., an equivalence ratio [OH]/[COOH]) of a polyol (1) to a polycarboxylic acid (2) is from 2/1 to 1/1, preferably from 1.5/1 to 1/1 and more preferably from 1.3/1 to 1.02/1.

Specific examples of the polyisocyanates (3) include aliphatic polyisocyanates (e.g., tetramethylene diisocyanate, hexamethylene diisocyanate and 2,6-diisocyanate methylcaproate); alicyclic polyisocyanates (e.g., isophorone diisocyanate and cyclohexylmethane diisocyanate); aromatic diisosycantes (e.g., tolylene diisocyanate and diphenylmethane diisocyanate); aromatic aliphatic diisocyanates (e.g., α,α,α′,α′-tetramethyl xylylene diisocyanate); isocyanurates; blocked polyisocyanates in which the polyisocyanates mentioned above are blocked with phenol derivatives thereof, oximes or caprolactams; etc. These compounds can be used alone or in combination.

Suitable mixing ratio (i.e., [NCO]/[OH]) of a polyisocyanate (3) to a polyester having a hydroxyl group is from 5/1 to 1/1, preferably from 4/1 to 1.2/1 and more preferably from 2.5/1 to 1.5/1. When the [NCO]/[OH] ratio is too large, the low temperature fixability of the toner deteriorates. When the molar ratio of [NCO] is too small, the urea content of a modified polyester tends to be small and the anti hot offset property easily deteriorates.

The content of the constitutional component of a polyisocyanate (PIC) in the polyester prepolymer (A) having a polyisocyanate group at its end portion is from 0.5 to 40 by weight, preferably from 1 to 30% by weight and more preferably from 2 to 20% by weight. When the content is too low, the hot offset resistance of the toner deteriorates and in addition the heat resistance and low temperature fixability of the toner also deteriorate. In contrast, when the content is too high, the low temperature fixability of the toner deteriorates.

The number of isocyanate groups included in the prepolymer (A) per molecule is normally not less than 1, preferably from 1.5 to 3, and more preferably from 1.8 to 2.5. When the number of isocyanate groups is too small, the molecular weight of urea-modified polyester tends to be small and the anti-hot offset property easily deteriorates.

Specific examples of the amines (B) include diamines (B1), polyamines (B2) having three or more amino groups, amino alcohols (B3), amino mercaptans (B4), amino acids (B5), and blocked amines (B6), in which the amines (B1-B5) mentioned above are blocked.

Specific examples of the diamines (B1) include aromatic diamines (e.g., phenylene diamine, diethyltoluene diamine and 4,4′-diaminodiphenyl methane); alicyclic diamines (e.g., 4,4′-diamino-3,3′-dimethyldicyclohexyl methane, diaminocyclohexane and isophoron diamine); aliphatic diamines (e.g., ethylene diamine, tetramethylene diamine and hexamethylene diamine); etc.

Specific examples of the polyamines (B2) having three or more amino groups include diethylene triamine, and triethylene tetramine. Specific examples of the amino alcohols (B3) include ethanol amine and hydroxyethyl aniline. Specific examples of the amino mercaptan (B4) include aminoethyl mercaptan and aminopropyl mercaptan. Specific examples of the amino acids (B5) include amino propionic acid and amino caproic acid. Specific examples of the blocked amines (B6) include ketimine compounds which are prepared by reacting one of the amines B1-B5 mentioned above with a ketone such as acetone, methyl ethyl ketone and methyl isobutyl ketone; oxazoline compounds, etc. Among these compounds, diamines (B1) and mixtures in which a diamine (B1) is mixed with a small amount of a polyamine (B2) are preferred.

The molecular weight of the urea-modified polyesters can be controlled using a molecular-weight control agent, if desired. Specific preferred examples of the molecular-weight control agent include monoamines (e.g., diethyl amine, dibutyl amine, butyl amine and lauryl amine), and blocked amines (i.e., ketimine compounds) prepared by blocking the monoamines mentioned above.

The mixing ratio of the amines (B) to the prepolymer (A), i.e., the equivalent ratio ([NCO]/[NHx]) of the isocyanate group [NCO] contained in the prepolymer (A) to the amino group [NHx] contained in the amines (B), is normally from 1/2 to 2/1, preferably from 1.5/1 to 1/1.5 and more preferably from 1.2/1 to 1/1.2. When the mixing ratio is too large or too small, the molecular weight of the resultant urea-modified polyester (i) decreases, resulting in deterioration of the hot offset resistance of the resultant toner. The modified polyesters can include a urethane linkage as well as a urea linkage. The molar ratio (urea/urethane) of the urea linkage to the urethane linkage may vary from 100/0 to 10/90, preferably from 80/20 to 20/80 and more preferably from 60/40 to 30/70. When the content of the urea linkage is too low, the hot offset resistance of the resultant toner deteriorates.

The urea-modified polyesters (i) of the present invention can be prepared in different ways, including, for example, one-shot methods and prepolymer methods.

The weight average molecular weight of the urea-modified polyesters is not less than 10,000, preferably from 20,000 to 10,000,000 and more preferably from 30,000 to 1,000,000. The peak molecular weight is from 1,000 to 10,000. When the peak molecular weight is too small, elongation reaction tends to be not sufficiently conducted and the elasticity of the toner tends to be insufficient. Thus, the anti-hot offset easily deteriorates. When the peak molecular weight is too large, the fixing property may deteriorate and manufacturing cost tends to be high in terms of pulverization of toner. The number average molecular weight of the urea-modified polyesters is not particularly limited when the unmodified polyester resin described below is used in combination. Namely, controlling of the weight average molecular weight of the modified polyester resins has priority over controlling of the number average molecular weight thereof. However, when a urea-modified polyester is used alone, the number average molecular weight thereof is not greater than 20,000, preferably from 1,000 to 10,000 and more preferably from 2,000 to 8,000. When the number average molecular weight is too large, the low temperature fixability of the resultant toner deteriorates, and in addition the gloss of full color images decreases when the toner is used in a full color image forming apparatus.

By using a combination of a urea-modified polyester (i) with an unmodified polyester (ii), the low temperature fixability of the toner improves and in addition the toner can produce color images having high gloss when the toner is used in the full-color image forming apparatus.

As the polyester (ii), a polycondensation product of the polyol (1) and the polycalboxylic acid (2) as in the polyester (i) and preferred examples are the same as those for the polyester (i). The polyester (ii) can be modified by a chemical bond, for example, urethane linkage, other than urea linkage, in addition to the non-modified polyesters.

When a mixture of the polyester (i) and the polyester (ii) is used, it is preferred that the polyester (i) at least partially mix with the polyester (ii) in terms of the low temperature fixability and hot offset resistance of the resultant toner. Namely, it is preferred that the polyester (i) has a structure similar to that of the polyester (ii). The mixing ratio of the polyester (i) to the polyester (ii) varies from 5/95 to 80/20, preferably from 5/95 to 30/70, more preferably from 5/95 to 25/75, and even more preferably from 7/93 to 20/80. When the added amount of urea-modified polyester is too small, the hot offset resistance of the resultant toner deteriorates and, in addition, it is difficult to impart a good combination of high temperature preservability and low temperature fixability to the resultant toner.

The peak weight average molecular weight of the polyester (ii) is normally from 1,000 to 10,000, preferably from 2,000 to 8,000, and more preferably from 2,000 to 5,000. When the peak molecular weight is too small, the high temperature preservability tends to deteriorate. When the peak molecular weight is too large, the low temperature fixability tends to deteriorate. The hydroxyl group value of the polyester (ii) is preferably not less than 5 mgKOH/g, more preferably from 10 to 120 mgKOH/g and even more preferably 20 to 80 mgKOH/g. When the hydroxyl group value of the unmodified polyester (PE) is too low, it is disadvantageous to achieve a good combination of high temperature preservability and low temperature fixability. The acid value of the polyester (ii) is normally from 1 to 5 mgKOH/g, preferably from 2 to 4 mgKOH/g.

The toner of the present invention has a glass transition temperature (Tg) of the toner binder resin is from 40 to 55° C. A glass transition temperature that is too low causes deterioration of high temperature preservability of the toner. When the glass transition temperature is too high, wax does not easily ooze (by the observation of a heating and cooling device) so that the anti-hot offset property deteriorates. Under the coexistence of a urea-modified polyester resin, the toner of the present invention, which has a low glass transition point, can have a relatively excellent combination of high temperature preservability and anti-hot offset property in comparison with a known polyester based toner. This is because material functions are desirably arranged in the toner particle structure of the toner of the present invention.

Hydrophobic silica and/or hydrophobic titanium oxide for use in the toner of the present invention preferably have a primary particle diameter between 5 nm and 2 μm, and more preferably between 5 nm and 500 nm. In addition, it is preferred that the specific surface area of such particulate inorganic materials measured by a BET method be from 20 to 500 m²/g.

Suitable colorants for use in the toner of the present invention include known dyes and pigments.

Specific examples of the colorants include carbon black, Nigrosine dyes, black iron oxide, Naphthol Yellow S, Hansa Yellow (10G, 5G and G), Cadmium Yellow, yellow iron oxide, loess, chrome yellow, Titan Yellow, polyazo yellow, Oil Yellow, Hansa Yellow (GR, A, RN and R), Pigment Yellow L, Benzidine Yellow (G and GR), Permanent Yellow (NCG), Vulcan Fast Yellow (5G and R), Tartrazine Lake, Quinoline Yellow Lake, Anthrazane Yellow BGL, isoindolinone yellow, red iron oxide, red lead, orange lead, cadmium red, cadmium mercury red, antimony orange, Permanent Red 4R, Para Red, Fire Red, p-chloro-o-nitroaniline red, Lithol Fast Scarlet G, Brilliant Fast Scarlet, Brilliant Carmine BS, Permanent Red (F2R, F4R, FRL, FRLL and F4RH), Fast Scarlet VD, Vulcan Fast Rubine B, Brilliant Scarlet G, Lithol Rubine GX, Permanent Red F5R, Brilliant Carmine 6B, Pigment Scarlet 3B, Bordeaux 5B, Toluidine Maroon, Permanent Bordeaux F2K, Helio Bordeaux BL, Bordeaux 10B, BON Maroon Light, BON Maroon Medium, Eosin Lake, Rhodamine Lake B, Rhodamine Lake Y, Alizarine Lake, Thioindigo Red B, Thioindigo Maroon, Oil Red, Quinacridone Red, Pyrazolone Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, Indanthrene Blue (RS and BC), Indigo, ultramarine, Prussian blue, Anthraquinone Blue, Fast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, lithopone and the like. These materials can be used alone or in combination. The content of the colorant is from 1 to 15% by weight and preferably from 3 to 100 by weight based on the toner.

Master batch pigments, which are prepared by combining a colorant with a resin, can be used as the colorant of the toner composition of the present invention. Specific examples of the resins for use in the master batch pigments or for use in combination with master batch pigments include the modified polyester resins and the unmodified polyester resins mentioned above; styrene polymers and substituted styrene polymers such as polystyrene, poly-p-chlorostyrene and polyvinyltoluene; styrene copolymers such as styrene-p-chlorostyrene copolymers, styrene-propylene copolymers, styrene-vinyltoluene copolymers, styrene-vinylnaphthalene copolymers, styrene-methyl acrylate copolymers, styrene-ethyl acrylate copolymers, styrene-butyl acrylate copolymers, styrene-octyl acrylate copolymers, styrene-methyl methacrylate copolymers, styrene-ethyl methacrylate copolymers, styrene-butyl methacrylate copolymers, styrene-methyl α-chloromethacrylate copolymers, styrene-acrylonitrile copolymers, styrene-vinyl methyl ketone copolymers, styrene-butadiene copolymers, styrene-isoprene copolymers, styrene-acrylonitrile-indene copolymers, styrene-maleic acid copolymers and styrene-maleic acid ester copolymers; and other resins such as polymethyl methacrylate, polybutyl methacrylate, polyvinyl chloride, polyvinyl acetate, polyethylene, polypropylene, polyesters, epoxy resins, epoxy polyol resins, polyurethane resins, polyamide resins, polyvinyl butyral resins, acrylic resins, rosin, modified rosins, terpene resins, aliphatic or alicyclic hydrocarbon resins, aromatic petroleum resins, chlorinated paraffin, paraffin waxes, etc. These resins can be used alone or in combination.

Methods of manufacturing the toner of the present invention are described below.

Suitable aqueous media for use in the present invention include water, and mixtures of water with a solvent which can be mixed with water. Specific examples of such a solvent include alcohols (e.g., methanol, isopropanol and ethylene glycol), dimethylformamide, tetrahydrofuran, cellosolves (e.g., methyl cellosolve), lower ketones (e.g., acetone and methyl ethyl ketone), etc.

In the present invention, urea-modified polyester (UMPE) can be obtained by conducting the reaction between polyester prepolymer (A) having an isocyanate group and amine (B) in an aqueous medium. As a method of securely forming a dispersion body formed of a modified polyester, for example, urea-modified polyester, or prepolymer (A) in an aqueous medium, a composition of toner materials containing a modified polyester, for example, urea-modified polyester, or prepolymer (A) in an aqueous medium is added to an aqueous medium followed by shearing for dispersion. Prepolymer (A) and other toner compositions (hereinafter referred to as toner materials), for example, a colorant, a colorant master batch, a releasing agent, a charge controlling agent and an unmodified polyester resin can be mixed when forming a dispersion body in an aqueous medium. It is preferred to mix the toner materials in advance and add the mixture to an aqueous medium for dispersion. In addition, toner materials, for example, a colorant, a releasing agent and a charge controlling agent are not necessarily mixed during formation of particles in an aqueous medium but can be added after particles are formed. For example, particles not containing a colorant are formed first and a colorant can be added to the particles by a known dying method.

In the present invention, oil phase for emulsification can be formed by using a non-modified polyester binder resin as an only binder resins. Liquid dispersion for emulsification using a modified laminar inorganic mineral can be used to form toner particles.

There is no particular restriction for the dispersion method. Low speed shearing methods, high speed shearing methods, friction methods, high pressure jet methods, ultrasonic methods, etc., can preferably be used. Among these methods, high speed shearing methods are more preferred because particles having a particle diameter of from 2 to 20 μm can be easily prepared. When a high speed shearing type dispersion machine is used, there is no particular limit to the rotation speed thereof, but the rotation speed is typically from 1,000 to 30,000 rpm, and preferably from 5,000 to 20,000 rpm. The dispersion time is also not particularly limited, but is typically from 0.1 to 5 minutes for a batch production method. The temperature in the dispersion process is typically from 0 to 150° C. (under pressure), and preferably from 40 to 98° C. The dispersion process is preferably performed at a high temperature because the dispersion body containing a urea-modified polyester and a prepolymer (A) has a low viscosity at a high temperature so that dispersion can be easily performed.

In the present invention, the content of the aqueous medium is normally from 50 to 2,000 parts by weight and preferably from 100 to 1,000 parts by weight per 100 parts by weight of a toner component containing urea-modified polyester and prepolymer (A). When the content of the aqueous medium is too small, the toner constituent liquid mixture tends not to disperse well and thereby toner particles having a desired particle diameter are difficult to obtain. When the content is too large, the manufacturing cost increases. It is also possible to add a dispersing agent to an aqueous medium, which makes it possible to have a narrow particle size distribution of a dispersion body and improve the dispersion stability.

Various kinds of dispersing agents are used for dispersing a toner component in an oil phase and emulsifying an oil phase in an aqueous medium. Specific examples of such dispersing agents include a surface active agent, an inorganic particulate and a polymer particulate dispersing agent.

Specific examples of the surface active agents include anionic dispersing agents, for example, alkylbenzene sulfonic acid salts, α-olefin sulfonic acid salts, and phosphoric acid salts; cationic dispersing agents, for example, amine salts (e.g., alkyl amine salts, aminoalcohol fatty acid derivatives, polyamine fatty acid derivatives and imidazoline), and quaternary ammonium salts (e.g., alkyltrimethyl ammonium salts, dialkyldimethyl ammonium salts, alkyldimethyl benzyl ammonium salts, pyridinium salts, alkyl isoquinolinium salts and benzethonium chloride); nonionic dispersing agents, for example, fatty acid amide derivatives, polyhydric alcohol derivatives; and ampholytic dispersing agents, for example, alanine, dodecyldi(aminoethyl)glycin, di)octylaminoethyle)glycin, and N-alkyl-N,N-dimethylammonium betaine.

A good dispersion can be prepared with an extremely small amount of a surface active agent having a fluoroalkyl group. Specific examples of the anionic surface active agents having a fluoroalkyl group include fluoroalkyl carboxylic acids having from 2 to 10 carbon atoms and their metal salts, disodium perfluorooctanesulfonylglutamate, sodium 3-{omega-fluoroalkyl(C6-C11)oxy}-1-alkyl(C3-C4) sulfonate, sodium 3-{omega-fluoroalkanoyl(C6-C8)-N-ethylamino}-1-propanesulfonate, fluoroalkyl (C11-C20) carboxylic acids and their metal salts, perfluoroalkylcarboxylic acids and their metal salts, perfluoroalkyl(C4-C12)sulfonate and their metal salts, perfluorooctanesulfonic acid diethanol amides, N-propyl-N-(2-hydroxyethyl)perfluorooctanesulfone amide, perfluoroalkyl(C6-C10)sulfoneamidepropyltrimethylammonium salts, salts of perfluoroalkyl(C6-C10)-N-ethylsulfonyl glycin, monoperfluoroalkyl(C6-C16)ethylphosphates, etc.

Specific examples of the marketed products of such surface active agents having a fluoroalkyl group include SURFLON® S-111, S-112 and S-113, which are manufactured by Asahi Glass Co., Ltd.; FRORARD® FC-93, FC-95, FC-98 and FC-129, which are manufactured by Sumitomo 3M Ltd.; UNIDYNE® DS-101 and DS-102, which are manufactured by Daikin Industries, Ltd.; MEGAFACE® F-110, F-120, F-113, F-191, F-812 and F-833 which are manufactured by Dainippon Ink and Chemicals, Inc.; ECTOP® EF-102, 103, 104, 105, 112, 123A, 306A, 501, 201 and 204, which are manufactured by Tohchem Products Co., Ltd.; FUTARGENT® F-100 and F150 manufactured by Neos; etc.

Specific examples of the cationic surface active agents having a fluoroalkyl group include primary, secondary and tertiary aliphatic amino acids, aliphatic quaternary ammonium salts (for example, perfluoroalkyl(C6-C10)sulfoneamidepropyltrimethyl ammonium salts), benzalkonium salts, benzetonium chloride, pyridinium salts, and imidazolinium salts. Specific examples of commercially available products of these elements include SURFLON® S-121 (from Asahi Glass Co., Ltd.); FRORARD® FC-135 (from Sumitomo 3M Ltd.); UNIDYNE® DS-202 (from Daikin Industries, Ltd.); MEGAFACE® F-150 and F-824 (from Dainippon Ink and Chemicals, Inc.); ECTOP® EF-132 (from Tohchem Products Co., Ltd.); FUTARGENT® F-300 (from Neos); etc.

In addition, a water hardly soluble inorganic dispersing agents can be used. Specific examples thereof include tricalcium phosphate, calcium carbonate, titanium oxide, colloidal silica and hydroxyapatite.

Polymer particulates have been confirmed to have the same effect as an inorganic compound.

Specific examples of the particulate polymers include particulate polymethyl methacylate having a particle diameter of from 1 to 3 μm, particulate polystyrene having a particle diameter of from 0.5 to 2 μm, particulate styrene-acrylonitrile copolymers having a particle diameter of 1 μm, etc. Specific examples of the marketed particulate polymers include PB-200H (from Kao Corp.), SGP (Soken Chemical & Engineering Co., Ltd.), TECHNOPOLYMER® SB (Sekisui Plastics Co., Ltd.), SPG-3G (Soken Chemical & Engineering Co., Ltd.), MICROPEARL® (Sekisui Fine Chemical Co., Ltd.), etc.

Furthermore, it is possible to stably disperse toner components in an aqueous medium using a polymeric protection colloid. Specific examples of such protection colloids include polymers and copolymers prepared using monomers, for example, acids (e.g., acrylic acid, methacrylic acid, α-cyanoacrylic acid, α-cyanomethacrylic acid, itaconic acid, crotonic acid, fumaric acid, maleic acid and maleic anhydride), acrylic monomers having a hydroxyl group (e.g., β-hydroxyethyl acrylate, β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethyleneglycolmonoacrylic acid esters, diethyleneglycolmonomethacrylic acid esters, glycerinmonoacrylic acid esters, N-methylolacrylamide and N-methylolmethacrylamide), vinyl alcohol and its ethers (e.g., vinyl methyl ether, vinyl ethyl ether and vinyl propyl ether), esters of vinyl alcohol with a compound having a carboxyl group (i.e., vinyl acetate, vinyl propionate and vinyl butyrate); acrylic amides (e.g., acrylamide, methacrylamide and diacetoneacrylamide) and their methylol compounds, acid chlorides (e.g., acrylic acid chloride and methacrylic acid chloride), and monomers having a nitrogen atom or an alicyclic ring having a nitrogen atom (e.g., vinyl pyridine, vinyl pyrrolidone, vinyl imidazole and ethylene imine).

In addition, polymers, for example, polyoxyethylene compounds (e.g., polyoxyethylene, polyoxypropylene, polyoxyethylenealkyl amines, polyoxypropylenealkyl amines, polyoxyethylenealkyl amides, polyoxypropylenealkyl amides, polyoxyethylene nonylphenyl ethers, polyoxyethylene laurylphenyl ethers, polyoxyethylene stearylphenyl esters, and polyoxyethylene nonylphenyl esters), and cellulose compounds, for example, methyl cellulose, hydroxyethyl cellulose and hydroxypropyl cellulose, can also be used as the polymeric protective colloid.

To remove an organic solvent from the obtained emulsified dispersion body, the entire system is gradually heated while stirring in a layer streaming manner. After violent stirring in a certain temperature range and desolvent, toner particles having a spindle form or dimpled toner can be manufactured.

When compounds, for example, calcium phosphate, which are soluble in an acid or alkali, are used as a dispersion stabilizer, it is possible to dissolve the compounds by adding an acid, for example, hydrochloric acid, followed by washing of the resultant particles with water, to remove the compounds from toner mother particles. In addition, a zymolytic method can be used to remove such compounds.

When a dispersing agent is used, it is possible to allow the dispersing agent remain on the surface of toner particles. When a solvent is used, a dispersing agent can be removed from the resultant obtained after elongation and/or cross-linking reaction by amine of modified polyester (prepolymer) under normal or reduced pressure.

To decrease the viscosity of a medium dispersion containing a toner component, it is possible to use an organic solvent in which polyester, for example, urea-modified polyester and prepolymer (A), can be dissolved. It is preferred to use a solvent because the particle size distribution can be sharp.

The organic solvent is preferred to be volatile and have a boiling point lower than 100° since it is easy to get removed. Specific examples thereof include non-water soluble solvents, for example, aqueous toluene, xylene, benzene, carbon tetrachloride, methylene chloride, 1,2-dichloroethane, 1,1,2-trichloroethane, trichloroethylene, chloroform, monochlorobenzene, methyl acetate and ethyl acetate, methylethyl ketone and methylisobuthyl ketone. These can be used alone or in combination. Especially, aromatic hydrocarbons, for example, toluene and xylene, and halogenated hydrocarbons, for example, methylene chloride, 1,2-dichloroethane, chloroform and carbon tetrachloride, are preferred.

The content of the organic solvent is from 0 to 300 parts by weight, preferably from 0 to 100 parts by weight and more preferably from 25 to 70 parts by weight based on 100 parts by weight of prepolymer (A).

To remove the organic solvent from the obtained emulsified dispersion body, there can be used a method in which the entire system is gradually heated to completely evaporate and remove the organic solvent in droplets. Alternatively, a drying method can be used in which the dispersing body is sprayed in a dry atmosphere to completely evaporate and remove not only the non-water soluble organic solvent in droplets to form toner mother particles but also the remaining dispersing agent. The dry atmosphere can be prepared by heating gases, for example, air, nitrogen, carbon dioxide and combustion gases. The temperature of the heated gases is preferred to be higher than the boiling point of the solvent having the highest boiling point among the solvents used in the dispersion. By using a drying apparatus, for example, a spray dryer, a belt dryer, a rotary kiln, the drying treatment can be completed in a short period of time.

It is deduced that violent stirring makes the form from spherical to spindle while ethyl acetate contained in a liquid emulsion can decrease the viscosity during granulation. As described above, the volume average particle diameter Dv, the number average particle diameter Dn, the ratio (Dv/Dn) thereof, and the ratio of spindle form can be controlled by adjusting, for example, aqueous phase viscosity, oil phase viscosity, characteristics of resin particulates and the content of addition.

The toner of the present invention can be used for a two-component developer in which the toner is mixed with a carrier. The weight ratio (T/C) of the toner (T) to the carrier (C) is preferably from 1/100 to 10/100.

Suitable carriers for use in a two component developer include known carrier materials, for example, iron powders, ferrite powders and magnetite powders which have a particle diameter of from about 20 to about 200 μm. The surface of the carriers can be coated by a resin. Specific examples of such resins to be coated on the carriers include amino resins, for example, urea-formaldehyde resins, melamine resins, benzoguanamine resins, urea resins, and polyamide resins, and epoxy resins. In addition, there are also included vinyl or vinylidene resins, for example, acrylic resins, polymethylmethacrylate resins, polyacrylonitirile resins, polyvinyl acetate resins, polyvinyl alcohol resins, polyvinyl butyral resins, polystyrene resins, styrene-acrylic copolymers, halogenated olefin resins, for example, polyvinyl chloride resins, polyester resins, for example, polyethyleneterephthalate resins and polybutyleneterephthalate resins, polycarbonate resins, polyethylene resins, polyvinyl fluoride resins, polyvinylidene fluoride resins, polytrifluoroethylene resins, polyhexafluoropropylene resins, vinylidenefluoride-acrylate copolymers, vinylidenefluoride-vinylfluoride copolymers, fluoroterpolymers, for example, a copolymer of tetrafluoroethylene, fluorovinylidene and other monomers including no fluorine atom, and silicone resins.

If desired, the electroconductive powder can be optionally included in the resin. Specific examples of such electroconductive powders include metal powders, carbon blacks, titanium oxide, tin oxide, and zinc oxide. The average particle diameter of such electroconductive powders is preferably not greater than 1 μm. When the particle diameter is too large, it is hard to control the resistance of the resultant toner.

The toner of the present invention can also be used as a one-component magnetic developer or a one-component non-magnetic developer.

When the volume average particle diameter of a toner contained in a two-component developing agent is too small, the toner tends to be attached to the surface of a carrier during stirring in a developing device over an extended period of time. Thus, the charging ability of the carrier may deteriorate. When such a toner is used in a one-component developing agent, filming of the toner on a developing roller and attachment thereof to a member, for example, a blade for regulating the layer of the toner, easily occur.

In addition, these phenomena and the content ratio of fine toner particles have a significant relationship. When the ratio of toner particles having a particle diameter not greater than, for example, 3 μm, is not less than 10%, it may be difficult to prevent the attachment to carrier and to secure a high level charging ability.

To the contrary, when the volume average particle diameter of a toner is too large, it is difficult to obtain quality images with high definition. When such a toner contained in a developing agent is replenished, the particle diameter of the toner significantly varies in most cases. When the ratio of the weight average particle diameter to the number average particle diameter of a toner is greater than, for example, 1.20, it is found that the same applies to the toner.

The average particle diameter and size distribution of a toner can be measured by Coulter Counter method.

Specific examples of devices measuring particle size distribution of toner particles include COULTER COUNTER TA-II and COULTER MULTI-SIZER IIe (both are manufactured by Beckman Coulter Inc.). COULTER COUNTER MULTI-SIZER TA-II is connected to an interface (manufactured by the institute of Japanese Union of Science and Engineers) and a PC9801 personal computer (manufactured by NEC Corporation) to measure the number distribution and the volume distribution.

The measuring method is described below.

(1) Add 0.1 to 5 ml of a surface active agent (preferably a salt of an alkyl benzene sulfide) as a dispersing agent to 100 to 150 ml of an electrolytic aqueous solution. The electrolytic aqueous solution is an about 1% NaCl aqueous solution prepared by using primary NaCl (e.g., ISOTON-II®, manufactured by Beckman Coulter Inc.).

(2) Add 2 to 20 mg of a measuring sample to the electrolytic aqueous solution.

(3) The electrolytic aqueous solution in which the measuring sample is suspended is subject to a dispersion treatment for 1 to 3 minutes with a supersonic disperser.

(4) Measure the volume and the number of toner particles or toner with the aperture set to 100 μm for the measuring device mentioned above to calculate the volume distribution and the number distribution.

The whole range is a particle diameter of from 2.00 to not greater than 40.30 μm and the number of the channels is 13.

These channels are: from 2.00 to not greater than 2.52 μm; from 2.52 to not greater than 3.17 μm; from 3.17 to not greater than 4.00 μm; from 4.00 to not greater than 5.04 μm; from 5.04 to not greater than 6.35 μm; from 6.35 to not greater than 8.00 μm; from 8.00 to not greater than 10.08 μm; from 10.08 to not greater than 12.70 μm; from 12.70 to not greater than 16.00 μm, from 16.00 to not greater than 20.20 μm; from 20.20 to not greater than 25.40 μm; from 25.40 to not greater than 32.00 μm; and from 32.00 to not greater than 40.30 μm.

The volume average particle diameter (Dv) obtained by the volume distribution, the number average particle diameter (Dv) obtained by the number distribution and the ratio (Dv/Dn) are obtained.

Carrier for Two Component Developing Agent

When the toner of the present invention is used in a two-component developing agent, the toner can be mixed with a magnetic carrier for use. The content ratio of toner to carrier in a developing agent is preferably from 1 to 10 parts by weight based on 100 parts by weight of the carrier.

Suitable magnetic carriers for use in a two component developer include known carrier materials, for example, iron powders, ferrite powders, magnetite powders, magnetic resin carriers, which have a particle diameter of from about 20 to about 200 μm. The surface of the carriers may be coated by a resin.

Specific examples of such resins to be coated on the carriers include amino resins such as urea-formaldehyde resins, melamine resins, benzoguanamine resins, urea resins, polyamide resins, and epoxy resins. In addition, vinyl or vinylidene resins, for example, acrylic resins, polymethylmethacrylate resins, polyacrylonitirile resins, polyvinyl acetate resins, polyvinyl alcohol resins, polyvinyl butyral resins, polystyrene resins, styrene-acrylic copolymers, halogenated olefin resins, for example, polyvinyl chloride resins, polyester resins, for example, polyethyleneterephthalate resins and polybutyleneterephthalate resins, polycarbonate resins, polyethylene resins, polyvinyl fluoride resins, polyvinylidene fluoride resins, polytrifluoroethylene resins, polyhexafluoropropylene resins, vinylidenefluoride-acrylate copolymers, vinylidenefluoride-vinylfluoride copolymers, copolymers of tetrafluoroethylene, vinylidenefluoride and other monomers including no fluorine atom, and silicone resins.

If desired, an electroconductive powder may be included in the toner. Specific examples of such electroconductive powders include metal powders, carbon blacks, titanium oxide, tin oxide, and zinc oxide. The average particle diameter of such electroconductive powders is preferably not greater than 1 μm. When the particle diameter is too large, it is hard to control the resistance of the resultant toner.

The toner of the present invention can also be used as a one-component magnetic developer or a one-component non-magnetic developer.

As described above, the status how wax particles are dispersed in a toner particle and on the surface thereof can be found by observing a slice of the toner particle with a transmission electron microscope (TEM). According to this observation, it is found that wax particles having a diameter from 0.2 to 1.0 μm are dispersed near the surface of a toner particle. Portion near the surface is quantity-analyzed. With further regards to ATR-IR, when the relative strength of wax particles is measured using a wavelength of 2,850 cm⁻¹, C—H vibration of the wax can be measured. The depth of measurement is about 0.3 μm and is from 0.2 to 1.2 μm considering the accuracy of absorption wavelength.

Typically, the content of wax is quantified by X ray irradiation analysis, for example, ESCA but the analysis depth is not less than 2 μm, almost all of the put-in content of wax is the value obtained.

Next, a wax dispersing agent is used for dispersing wax near the surface of a toner particle. The status of dispersion can be controlled by the amount of a wax dispersing agent.

The dispersing agent for use in the present invention has typically, for example, a grafted polymer (C) the structure of which is that at least some of a polyolefin resin (A) is grafted by a vinyl based resin (B).

In the toner of the present invention, at least some of a releasing agent is encapsulated in the graft polymer (C). Encapsulation represents “since the portion of polyolefin resin (A) in a graft polymer (C) is compatible with a releasing agent, the releasing agent is selectively taken in or attached to the portion of the polyolefin resin (A) in the graft polymer (C)”.

When a toner is made as follows: (1) a toner component containing a polyester resin is dissolved and/or dispersed in an organic medium; (2) the resultant solution or dispersion body is dispersed in an aqueous medium under the presence of an inorganic dispersing agent or polymer particulates to conduct polyaddition reaction of the resultant solution or dispersion body; and (3) the solvent of the obtained emulsified dispersion body is removed, graft polymer (C) in which at least some of a polyolefin resin (A) is modified by a vinyl based resin (B) is positioned between a releasing agent and a toner binder. As a result, the releasing agent can be prevented from emerging to the surface of a toner particle. Thus, poor dispersion can be prevented. Poor dispersion means that the release agent having a high polar linkage portion is negatively attached to a modified polyester as a toner binder at the interface therebwtween so that the releasing agent selectively moves to the surface of the toner particle and the release agent having a few high polar linkage portion moves to the center of the toner particle. Also the releasing agent can quickly have an effect when the releasing agent passes through a fixing device since the toner securely has a releasing agent having a suitable dispersion particle diameter near the surface thereof.

In the case of the toner of the present invention, various kinds of drawbacks seen in a typical toner particle having a releasing agent near the surface thereof are hardly seen even. Therefore, it is possible to make the dispersion particle diameter of a releasing agent relatively large. Consequently, the releasing agent easily oozes from the surface of the toner particle and has a high releasing performance.

In addition, when a graft polymer (C) has a large dispersion particle diameter in the resin, the graft polymer (C) easily takes in or attracts a releasing agent so that the releasing agent easily oozes or detaches from the toner. However, when the dispersion particle diameter of the graft polymer (C) in a resin is too large, a releasing agent encapsulated therein tends to have a large dispersion particle diameter.

The content of a releasing agent contained in a graft polymer (C) is from 33 to 1,000 parts by weight, preferably from 50 to 300 parts by weight based on 100 parts of the graft polymer (C). It is preferred that at least 80%, preferably 90%, of all wax contained in a toner is contained in a graft polymer (C).

Process Cartridge

In the present invention, a process cartridge can be detachably attached to the main body of an image forming apparatus, for example, a photocopier and a printer, which integrally includes an image bearing member (e.g., a photoreceptor) and a developing device with optional devices, for example, a charging device, a cleaning device and a transfer device.

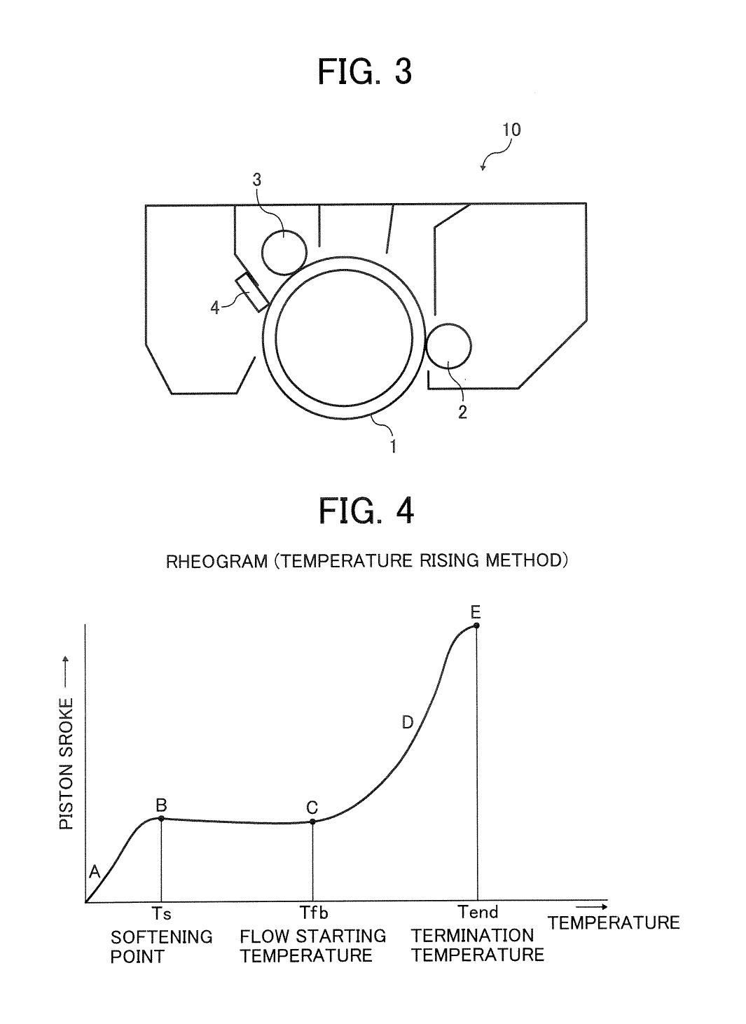

FIG. 3 is a conceptual diagram illustrating an example of a process cartridge 10 containing the toner of the present invention:

This process cartridge 10 has a drum form photoreceptor 1 as a latent image bearing member around which a non-contact closely positioned roller type charging device 3, a developing device 2 and a cleaning device 4 are arranged. The developing device 2 includes a developing agent accommodation portion, a toner accommodation portion connected thereto via a toner replenishing path, a magnet roller, a developing agent supply regulating device and a developing agent accommodation case. The developing agent accommodation portion magnetically scoops a developing agent formed of a toner and a magnetic carrier and charges the developing agent by stirring with a developing agent stirring device. The charged developing agent is supplied to a development sleeve. The developing agent supply regulating device regulates the amount of a developing agent supplied to the development sleeve. The toner accommodation portion has a toner stirring device. The cleaning device 4 has a collected toner accommodation tank to accommodate toner scraped down by a cleaning blade from the development surface.

The invention also relates to a method of manufacturing a toner particle comprising dispersing or emulsifying a toner constituent liquid mixture comprising an organic solvent, a colorant, the binder resin and/or a precursor of the binder resin, a releasing agent and a laminar inorganic mineral in which part or all ions present between layers therein are modified by organic ions, in an aqueous medium comprising water to obtain a liquid dispersion or an emulsion; and removing the organic solvent and water from the liquid dispersion or the emulsion, the method preferably producing a toner particle having a structure such that when the particle is heated at a temperature ranging from 65 to 90° C. the releasing agent is melted on the outside of the toner particle to form a colored particle having a sea-island structure. The invention method preferably uses a constituent liquid mixture having a non-Newtonian index tan θ of from 0.75 to 0.95 at 25° C., and/or a Casson yield value of from 1 to 10 Pa at 25° C. and the toner particle has a form factor SF-1 of from 140 to 200.

Other preferred aspects of the invention include:

a developing agent comprising the invention and a carrier;

an image forming apparatus comprising:
an image bearing member configured to bear a latent image thereon;
a charging device configured to charge the image bearing member;
a developing device configured to develop the latent image comprising the toner of the invention;
a transfer device configured to transfer the latent image to a transfer body;
a discharging device configured to discharge the image bearing member; and
a cleaning device configured to clean the surface of the image bearing member;

a method of forming an image comprising:
charging an image bearing member by a charging device;
irradiating the image bearing member by an irradiating device to form a latent electrostatic image thereon;
developing the latent electrostatic image on the image bearing member with the developing agent of the invention;
removing residual toner remaining on the image bearing member by a cleaning device; and
transferring the toner image to a transfer body;

a toner container comprising a container and, therein, the toner of the invention; and

a process cartridge comprising;
an image bearing member configured to bear a latent electrostatic image;
a developing device configured to develop the latent electrostatic image comprising the toner of the invention; and
at least one optional device selected from a group consisting of a cleaning device, a transfer device, an irradiating device and a charging device.

Having generally described preferred embodiments of this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

### Example 1

Synthesis of Emulsion of Organic Particulates

### Manufacturing Example 1

<Particulate Liquid Dispersion 1>

The following recipe is placed in a reaction container equipped with a stirrer and a thermometer and the mixture is agitated for 15 minutes at a revolution of 400 rpm to obtain a white emulsion.

| | | |
|---|---|---|
| Water | 780 | parts |
| Sodium salt of sulfate of an adduct of methacrylic acid with | 11 | parts |
| ethyleneoxide (EREMINOR RS-30 manufactured by Sanyo | | |
| Chemical Industries Ltd.) | | |
| Styrene | 90 | parts |
| Methacrylic acid | 90 | parts |
| Butyl acrylate | 120 | parts |
| Ammonium persulfate | 1 | part |

The emulsion is heated at 75° C. to conduct a reaction for 5 hours. Then, 30 parts of a 1% aqueous solution of ammonium persulfate are added to the emulsion and the mixture is further aged for 5 hours at 75° C. Thus, an aqueous liquid dispersion (Particulate liquid dispersion 1) of a vinyl based cross-linking resin (i.e., a copolymer of styrene, methacrylic acid, and butyl acrylate) is obtained. The volume average particle diameter of Particulate liquid dispersion 1 is 50 nm when measured by LA-920.

<Particulate Liquid Dispersion 2>

Particulate liquid dispersion 2 is prepared in the same manse as in Particulate liquid dispersion 1 except that

<Particulate Liquid Dispersion 2>

The following recipe is placed in a reaction container equipped with a stirrer and a thermometer and the mixture is agitated for 15 minutes at a revolution of 400 rpm to obtain a white emulsion.

| | | |
|---|---|---|
| Water | 683 | parts |
| Sodium salt of sulfate of an adduct of methacrylic acid with | 11 | parts |
| ethyleneoxide (EREMINOR RS-30 manufactured by Sanyo | | |
| Chemical Industries Ltd.) | | |
| Styrene | 90 | parts |
| Methacrylic acid | 100 | parts |
| Butyl acrylate | 110 | parts |
| Ammonium persulfate | 1 | part |

The emulsion is heated at 75° C. to conduct a reaction for 5 hours. Then, 30 parts of a 1% aqueous solution of ammonium persulfate are added to the emulsion and the mixture is further aged for 5 hours at 75° C. Thus, an aqueous liquid dispersion (Particulate liquid dispersion 2) of a vinyl based cross-linking resin (i.e., a copolymer of styrene, methacrylic acid, and butyl acrylate) is obtained. The volume average particle diameter of Particulate liquid dispersion 1 is 20 nm when measured by LA-920.

<Particulate Liquid Dispersion 3>

The following recipe is placed in a reaction container equipped with a stirrer and a thermometer and the mixture is agitated for 15 minutes at a revolution of 400 rpm to obtain a white emulsion.

| | | |
|---|---|---|
| Water | 683 | parts |
| Sodium salt of sulfate of an adduct of methacrylic acid with | 11 | parts |
| ethyleneoxide (EREMINOR RS-30 manufactured by Sanyo | | |
| Chemical Industries Ltd.) | | |
| Styrene | 90 | parts |
| Methacrylic acid | 100 | parts |
| Butyl acrylate | 110 | parts |
| 1.6 HDD Hexanediol acrylate | 20 | parts |
| Ammonium persulfate | 1 | part |

The emulsion is heated at 75° C. to conduct a reaction for 5 hours. Then, 30 parts of a 1% aqueous solution of ammonium persulfate are added to the emulsion and the mixture is further aged for 5 hours at 75° C. Thus, an aqueous liquid dispersion (Particulate liquid dispersion 2) of a vinyl based cross-linking resin (i.e., a copolymer of styrene, methacrylic acid, and butyl acrylate) is obtained. The volume average particle diameter of Particulate liquid dispersion 1 is 20 nm when measured by LA-920. Manufacturing Example 2

<Modified Laminar Inorganic Mineral Dispersion Body 1>

Ninety (90) parts of a binder resin (polyester resin: formed of adduct of Bisphenol A with propylene oxide succinic acid derivative, manufactured by Sanyo Chemical Industries Ltd., acid value: 10, Tg: 52° C.) is mixed and kneaded for 15 minutes by a two-roll with a setting of the roll surface temperature of 110° C. and the roll gap of 2 mm. Then, 10 parts of modified montmorillonite (Clayton HY, manufactured by Wilbur-Ellis Co., Ltd.) are placed into the polyester resin, kneaded for 30 minutes and cooled down to room temperature. The resultant is pulverized by a pulverizer to a size of 2 mm φ to obtain Modified laminar inorganic mineral dispersion body 1.

### Manufacturing Example 3

<Modified Laminar Inorganic Mineral Dispersion Body 2>

Eighty five (85) parts of a binder resin (polyester resin: formed of adduct of Bisphenol A with propylene oxide succinic acid derivative, manufactured by Sanyo Chemical Industries Ltd., acid value: 10, Tg: 52° C.) is mixed and kneaded for 15 minutes by a two-roll with a setting of the roll surface temperature of 110° C. and the roll gap of 2 mm. Then, 10 parts of modified montmorillonite (Clayton APA, manufactured by Wilbur-Ellis Co., Ltd.) are placed into the polyester resin, kneaded for 30 minutes and cooled down to room temperature. The resultant is pulverized by a pulverizer to a size of 2 mm φ to obtain Modified laminar inorganic mineral dispersion body 2.

Preparation of Aqueous Phase

### Manufacturing Example 4

### Aqueous Phase 1

Eighty (80) parts of Particle liquid dispersion 1 are mixed with 990 parts of water, 40 parts of a 48.5% aqueous solution of sodium dodecyldiphenyletherdisulfonate (EREMINOR MON-7 manufactured by Sanyo Chemical Industries, Ltd.), and 90 parts of ethyl acetate and a milk white liquid (Aqueous phase 1) is obtained.

### Manufacturing Example 5

### Aqueous Phase 2

Eighty (80) parts of Particle liquid dispersion 2 are mixed with 990 parts of water, 40 parts of a 48.5% aqueous solution of sodium dodecyldiphenyletherdisulfonate (EREMINOR MON-7 manufactured by Sanyo Chemical Industries, Ltd.), and 90 parts of ethyl acetate and a milk white liquid (Aqueous phase 2) is obtained.

### Manufacturing Example 6

### Aqueous Phase 3

Eighty (80) parts of Particle liquid dispersion 3 are mixed with 990 parts of water, 40 parts of a 48.5% aqueous solution of sodium dodecyldiphenyletherdisulfonate (EREMINOR MON-7 manufactured by Sanyo Chemical Industries, Ltd.), and 90 parts of ethyl acetate and a milk white liquid (Aqueous phase 3) is obtained.

Synthesis of Low Molecular Weight Polyester

### Manufacturing Example 7

### Low Molecular Weight Polyester 1

The following components are contained in a reaction container equipped with a condenser, stirrer and a nitrogen introducing tube to conduct a reaction at 230° C. for 8 hours followed by another reaction with a reduced pressure of 10 to 15 mmHg for 5 hours:

| | |
|---|---|
| Adduct of bisphenol A with 2 mol of ethylene oxide | 220 parts |
| Bisphenol A with 3 mole of propylene oxide | 561 parts |
| Isophthalic acid | 218 parts |
| Adipic acid | 48 parts |
| Dibutyl tin oxide | 2 parts |

Forty five (45) parts of trimellitic anhydride is added in the container to conduct a reaction at 180° C. under normal pressure for 2 hours and obtain Low molecular weight polyester resin 1. The weight average molecular weight (Mw) of Low molecular weight polyester resin 1 is 4,500 and the acid value thereof is 28.

The following components are contained in a container equipped with a condenser, a stirrer and a nitrogen introducing tube to conduct a reaction at 230° C. at normal pressure for 8 hours followed by another reaction for 5 hours with a reduced pressure of 10 to 15 mmHg to obtain Intermediate body polyester 1:

| | |
|---|---|
| Adduct of bisphenol A with 2 mole of ethylene oxide | 712 parts |
| Adduct of bisphenol A with 2 mole of propylene oxide | 84 parts |
| Terephthalic acid | 292 parts |
| Trimellitic anhydrate | 32 parts |
| Dibutyl tin oxide | 2 parts |

The obtained Intermediate body polyester 1 has a number average molecular weight of 2,100, a weight average molecular weight of 10,500, a glass transition temperature of 55° C., an acid value of 0.5 mgKOH/g and a hydroxyl value of 49 mgKOH/g.

Next, the following components are contained in a container equipped with a condenser, a stirrer and a nitrogen introducing tube to conduct a reaction at 100° C. for 5 hours to obtain Prepolymer 1:

| | |
|---|---|
| Intermediate body polyester 1 | 411 parts |
| Isophorone diisocyanate | 89 parts |
| Ethyl acetate | 500 parts |

Prepolymer 1 has an isolated isocyanate weight % of 1.48%.

Synthesis of Ketimine

### Manufacturing Example 9

### Ketimine 1

In a reaction container equipped with a stirrer and a thermometer, 60 parts of isophoronediamine and 140 parts of methyl ethyl ketone are mixed to obtain Ketimine compound I. The amine value of Ketimine compound I is 408.

Synthesis of Master Batch

### Manufacturing Example 10

### Master Batch 1

The following is mixed by a HENSCHEL MIXER to obtain a mixture in which water is soaked in a pigment agglomeration body.

| | |
|---|---|
| Carbon black (# 44, manufactured by Mitsubishi Chemical | 40 parts |
| Corporation) | |
| Binder resin: Polyester resin (manufactured by SanyoKasei | 60 parts |
| Co., Ltd., acid value: 10, Mw: 7,000, Tg: 52° C.) | |
| Water | 20 parts |

The mixture is mixed and kneaded for 60 minutes by a two-roll with the surface temperature of the rolls of 130° C. The resultant is pulverized to a size of 1 mm φ to obtain Master batch 1.

Manufacturing Oil Phase

The following is placed and mixed in a reaction container equipped with a stirrer and a thermometer:

| | |
|---|---|
| Low molecular weight polyester 1 | 378 parts |
| Paraffin wax (HNP-9, manufactured by Nippon Seiro Co., | 110 parts |
| Ltd., Melting point 75° C.) | |
| Ethyl acetate | 947 parts |

The mixture is agitated, heated to 80° C., and kept at 80° C. for 5 hours and then cooled down to 30° C. in 1 hour. Then, 500 parts of Master batch 1 and 500 parts of ethyl acetate are added to the reaction container and mixed for 1 hour to obtain Liquid material 1.

Then, 1,324 parts of Liquid material 1,110 parts of Laminar inorganic mineral 1 are transferred to a reaction container and dispersed using a bead mill (ULTRAVISCOMILL from AIMEX) under the following conditions to disperse the laminar inorganic mineral, carbon black and the wax:

Liquid feeding speed: 1 kg/hr,

Disc rotation speed: 6 m/sec,

Diameter of zirconia beads: 0.5 mm,

Filling factor: 80% by volume, and

Repeat number of dispersion treatment: 3 times.

Next, 1,324 parts of Low molecular weight polyester 1 of 65% by weight of ethyl acetic acid solution are added to the wax liquid dispersion. After 1 pass of the bead mill under the same condition mentioned above, Pigment wax liquid dispersion 1 is obtained. The density of the solid portion of Pigment wax liquid dispersion 1 is 50%.

Emulsification and Solvent Removal

The following components are contained in a container to be mixed for 1 minute using a TK HOMOMIXER (manufactured by Tokushu Kika Kogyo Co., Ltd.) at a rotation of 5,000 rpm.

| | | |
|---|---|---|
| Pigment wax liquid dispersion 1 | 618 | parts |
| Prepolymer 1 | 115 | parts |
| Ketimine compound 1 | 6.6 | parts |

Then, 1200 parts of Aqueous phase 1 are added thereto and the mixture is dispersed for 20 minutes using a TK HOMOMIXER at a rotation of 13,000 rpm. Thus, Emulsion slurry 1 is prepared.

In a container equipped with a stirrer and a thermometer, Emulsion slurry 1 is added and heated at 30° C. for 8 hours to remove the solvents therefrom. Subsequent to aging at 45° C. for 4 hours, Slurry dispersion 1 is obtained.

Washing and Drying

One hundred (100) parts of Emulsion slurry 1 are filtered by filtering under a reduced pressure. Then the following operations are performed.
(1) 100 parts of deionized water are added to the thus prepared cake and the mixture is mixed for 10 minutes by a TK HOMOMIXER at a revolution of 12,000 rpm and then filtered;
(2) 100 parts of a 10% aqueous solution of sodium hydroxide are added to the cake prepared in (1) and the mixture is mixed for 30 minutes by a TK HOMOMIXER at a rotation of 12,000 rpm while applying supersonic vibration thereto, and then filtered under a reduced pressure, wherein this washing using an alkali is repeated twice;
(3) 100 parts of a 10% hydrochloric acid are added to the cake prepared in (2) and the mixture is mixed for 10 minutes by a TK HOMOMIXER at a rotation of 12,000 rpm and then filtered; and
(4) 300 parts of deionized water are added to the cake prepared in (3) and the mixture is mixed for 10 minutes by a TK HOMOMIXER at a revolution of 12,000 rpm and then filtered, wherein this washing is repeated twice to prepare Filtered cake 1.

Filtered cake 1 is dried for 48 hours at 45° C. using a circulating drier. The dried cake is sieved using a screen having openings of 75 μm. One hundred (100) parts of the toner particles, 0.5 parts of hydrophobic silica and 0.5 parts of hydrophobic titan oxide are mixed in a HENSCHEL MIXER to prepare Toner 1 (volume average particle diameter: 5.85 μm, number average particle diameter: 4.33 μm, measured by MULTISIZER II).

### Example 2

Toner 2 is manufactured in the same manner as in Example 1 except that 110 parts of Laminar inorganic mineral dispersion body 1 of Manufacturing Example 2 is changed to 220 parts of Laminar inorganic mineral dispersion body 2 of Manufacturing Example 3 and Aqua phase 1 is changed to Aqua phase 2. Toner 2 has a volume average particle diameter (Dv) of 5.65 μm, a number average particle diameter (Dn) of 5.09 μm and Dv/Dn is 1.11.

### Manufacturing Example 12

### Low Molecular Weight Polyester 2

The following components are contained in a reaction container equipped with a condenser, stirrer and a nitrogen introducing tube to conduct a reaction at 230° C. for 8 hours followed by another reaction with a reduced pressure of 10 to 15 mmHg for 5 hours:

| | |
|---|---|
| Adduct of bisphenol A with 2 mol of ethylene oxide | 262 parts |
| Bisphenol A with 2 mole of propylene oxide | 202 parts |
| Bisphenol A with 3 mole of propylene oxide | 236 parts |
| Terephthalic acid | 266 parts |
| Maleic acid | 48 parts |
| Dibutyl tin oxide | 2 parts |

A reaction is conducted at 180° C. under normal pressure for 2 hours to obtain Low molecular weight polyester resin 2. The weight average molecular weight (Mw) of Low molecular weight polyester resin 1 is 3,900, Tg is 58° C. and the acid value thereof is 16.5.

Manufacturing Oil Phase

### Manufacturing Example 13

### Pigment Wax Liquid Dispersion 2

The following is placed and mixed in a reaction container equipped with a stirrer and a thermometer:

| | |
|---|---|
| Low molecular weight polyester 2 | 288 parts |
| Paraffin wax (HNP-3, manufactured by Nippon | 220 parts |
| Seiro Co., Ltd., Meltingpoint 75° C.) | |
| Ethyl acetate | 947 parts |

The mixture is agitated, heated to 80° C., and kept at 80° C. for 5 hours and then cooled down to 30° C. in 1 hour. Then, 500 parts of Master batch 1 and 500 parts of ethyl acetate are added to the reaction container and mixed for 1 hour to obtain Liquid material 2.

Then, 1,224 parts of Liquid material 2 are transferred to a reaction container and dispersed using a bead mill (ULTRAVISCOMILL from AIMEX) under the following conditions to disperse carbon black and the wax:

Liquid feeding speed: 1 kg/hr,

Disc rotation speed: 6 m/sec,

Diameter of zirconia beads: 0.5 mm,

Filling factor: 80′ by volume, and

Repeat number of dispersion treatment: 3 times.

Next, 1,224 parts of Low molecular weight polyester 2 of 65′ by weight of ethyl acetic acid solution are added to the wax liquid dispersion. After 1 pass of the bead mill under the same condition mentioned above, Pigment wax liquid dispersion 2 is obtained.

### Example 3

Toner 3 is manufactured in the same manner as in Example 2 except that Pigment wax liquid dispersion 2 is used instead of Pigment wax liquid dispersion 1. Toner 3 has a volume average particle diameter (Dv) of 4.95 μm, a number average particle diameter (Dn) of 4.19 μm and Dv/Dn is 1.18.

### Example 4

Toner 4 is manufactured in the same manner as in Example 2 except that 115 parts of Prepolymer 1 is changed to 50 parts. Toner 4 has a volume average particle diameter (Dv) of 5.60 μm, a number average particle diameter (Dn) of 4.96 μm and Dv/Dn is 1.13.

### Manufacturing Example 14

### Master Batch 2

The following is mixed by a HENSCHEL MIXER to obtain a mixture in which water is soaked in a pigment agglomeration body.

| | |
|---|---|
| Cyan pigment (ECB-301, manufactured by | 40 parts |
| Dainichiseika Color & Chemicals Mfg.Co., Ltd.) | |
| Binder resin: Polyester resin (manufactured by SanyoKasei | |
| Co., Ltd., acid value: 10, Mw: 7,000, Tg: 52° C.) | |
| Water | 20 parts |

The mixture is mixed and kneaded for 60 minutes by a two-roll with the surface temperature of the rolls of 130° C. The resultant is pulverized to a size of 1 mm φ to obtain Master batch 2.

### Manufacturing Example 15

### Master Batch 3

The following is mixed by a HENSCHEL MIXER to obtain a mixture in which water is soaked in a pigment agglomeration body.

| | |
|---|---|
| Magenta pigment (PR-F6B, manufactured by Clariant) | 40 parts |
| Binder resin: Polyester resin (manufactured by SanyoKasei | |
| Co., Ltd., acid value: 10, Mw: 7,000, Tg: 52° C.) | |
| Water | 20 parts |

The mixture is mixed and kneaded for 60 minutes by a two-roll with the surface temperature of the rolls of 130° C. The resultant is pulverized to a size of 1 mm φ to obtain Master batch 3.

### Manufacturing Example 16

### Master Batch 4

The following is mixed by a HENSCHEL MIXER to obtain a mixture in which water is soaked in a pigment agglomeration body.

| | |
|---|---|
| Yellow pigment (PY-HG, manufactured by Clariant) | 40 parts |
| Binder resin: Polyester resin (manufactured by SanyoKasei | |
| Co., Ltd., acid value: 10, Mw: 7,000, Tg: 52° C.) | |
| Water | 20 parts |

The mixture is mixed and kneaded for 60 minutes by a two-roll with the surface temperature of the rolls of 130° C. The resultant is pulverized to a size of 1 mm φ to obtain Master batch 4.

Manufacturing Oil Phase

### Manufacturing Example 17

### Pigment Wax Liquid Dispersion 3

The following is placed and mixed in a reaction container equipped with a stirrer and a thermometer:

| | |
|---|---|
| Low molecular weight polyester 2 | 278 parts |
| Paraffin wax (145° N, manufactured by Nippon Oil | 110 parts |
| Corporation,) | |
| Ethyl acetate | 947 parts |

The mixture is agitated, heated to 80° C., and kept at 80° C. for 5 hours and then cooled down to 30° C. in 1 hour. Then, 500 parts of Master batch 2 and 500 parts of ethyl acetate are added to the reaction container and mixed for 1 hour to obtain Liquid material 3.

Then, 1,324 parts of Liquid material 2 are transferred to a reaction container and dispersed using a bead mill (ULTRAVISCOMILL from AIMEX) under the following conditions to disperse carbon black and the wax:

Liquid feeding speed: 1 kg/hr,

Disc rotation speed: 6 m/sec,

Diameter of zirconia beads: 0.5 mm,

Filling factor: 80% by volume, and

Repeat number of dispersion treatment: 3 times.

Next, 1,324 parts of Low molecular weight polyester 2 of 65% by weight of ethyl acetic acid solution are added to the wax liquid dispersion. After 1 pass of the bead mill under the same condition mentioned above, Pigment wax liquid dispersion 3 is obtained.

### Example 5

The following components are contained in a container to be mixed for 1 minute using a TK HOMOMIXER (manufactured by Tokushu Kika Kogyo Co., Ltd.) at a rotation of 5,000 rpm.

| | |
|---|---|
| Pigment wax liquid dispersion 3 | 618 parts |
| Laminar inorganic mineral dispersion body 2 | 220 parts |
| Prepolymer 1 | 115 parts |
| Ketimine compound 1 | 6.6 parts |

Then, 1,200 parts of Aqueous phase 3 are added thereto and the mixture is dispersed for 20 minutes using a TK HOMOMIXER at a rotation of 13,000 rpm. Thus, Emulsion slurry 2 is prepared.

This mixture is transferred to a beaker equipped with a thermometer having an oar type stirring stick. The peripheral speed of stirring stick can be faster than 5 m/s. Forty (40) parts of viscosity improver (CELLOGEN BS-H-3, manufactured by Dai-ichi Kogyo Seiyaku Kogyo Co., Ltd.) are added to the slurry and the mixture is rapidly stirred at 30° C. for 2 hours at the peripheral speed of 6 m/s to obtain mother toner particles having a spindle form. For a desired spindle form, the stirring time can be prolonged. The solvent is removed with a reduced pressure at a temperature not higher than 50° C. in 1 hour. Subsequent to filtering, washing and drying, the resultant is air-classified to mother toner particle having a spindle form. Next, 0.5 parts of hydrophobic silica and 0.5 parts of hydrophobic titanium oxide are mixed with 100 parts of the mother toner particle by a HENSCHEL MIXER to obtain Toner 5 (volume average particle diameter: 5.32 μm, number average particle diameter: 4.25 μm, measured by MULTISIZER II).

### Example 6

### M Toner

Emulsion slurry 3 is manufactured in the same manner as in Example 5 except that Master batch 2 is replaced with Master batch 3 to obtain Toner 6 (volume average particle diameter (Dv): 5.95 μm, number average particle diameter (Dn): 5.04 μm, Dv/Dn: 1.18).

### Example 7

### Y Toner

Emulsion slurry 4 is manufactured in the same manner as in Example 5 except that Master batch 2 is replaced with Master batch 4 to obtain Toner 7 (volume average particle diameter (Dv): 4.85 μm, number average particle diameter (Dn): 4.61 μm, Dv/Dn: 1.05)

### Example 8

### BK Solution Suspension Toner

Toner 8 is obtained in the same manner as in Example 1 except that 115 parts of Prepolymer 1 and 6.6 parts of Ketimine Compound 1 are removed. Toner 8 has a volume average particle diameter (Dv) of 3.65 μm, a number average particle diameter (Dn) of 3.11 μm and a ratio (Dv/Dn) of 1.17.

### Example 9

### BK Solution Suspension Toner

Toner 9 is obtained in the same manner as in Example 5 except that 115 parts of Prepolymer 1 and 6.6 parts of Ketimine Compound 1 are removed. Toner 9 has a volume average particle diameter (Dv) of 5.30 μm, a number average particle diameter (Dn) of 4.77 μm and a ratio (Dv/Dn) of 1.11.

### Example 10

### Toner Process Evaluation

Black toner, which is manufactured in Example 4, cyan toner, which is manufactured in Example 5, magenta toner, which is manufactured in Example 6, and yellow toner, which is manufactured in Example 7, are used.

A covered carrier is used in which a ferrite core material having an average particle diameter of 50 μm is coated by 0.75% by weight of a resin of a copolymer of 2 hydroxyethyl methacrylate, methyl methacrylate and styrene and a copolymer of vinylidene fluoride and tetrafloroethylen with a weight ratio of 75/25 covers around based on the weight of the core material.

A developing agent is manufactured such that the toner density is 5′ and the total weight of the toner and the carrier is measured to be 1,000 g.

Each color developing agent in each color developing unit. A scorotron charger, a urethane cleaning blade and a fixing roller are used.

After power-on, a solid image is developed only at a first developing portion before the temperature of the fixing roller reaches a constant temperature. At the time, the toner is not transferred to a transfer paper (not supplied) but to the transfer belt. The toner image on the transfer belt passes through the second, third and fourth image forming portion. The transfer belt is cleaned at the cleaning portion. After the fixing portion reaches a constant temperature, a photocopying test having a run length of 100,000 is performed at a speed of 28 sheets per minute. After the run length, the cleaning property is good.

Preparation of Wax Particle Aqueous Liquid Dispersion

### Manufacturing Example 18

In a 1,000 ml beaker equipped with a stirring device, a thermosensor, a nitrogen introducing tube and a condenser, 28.5 g of NEWCOLE 565C (manufactured by Nippon Nyukazai Co., Ltd.), and 185.5 g of candelilla wax No. 1 (manufactured by CERARICA NODA Co., Ltd.) are added to 500 ml of de-aired distilled water. The system is heated with stirring in a nitrogen atmosphere. When the internal temperature is 85° C., an aqueous solution of 5N-sodium hydroxide is added thereto and the system is heated to 75° C. Subsequent to one-hour heating with stirring, the mixture is cooled down to room temperature to obtain Wax particle aqueous liquid dispersion 1.

Preparation of Colored Aqueous Liquid Dispersion

First, 100 g of carbon black (MOGUL L, manufactured by Cabot Corporation) and 25 g of dodecyl sodium sulfate are added to 540 ml. Subsequent to sufficient stirring, the entire system is dispersed by using a pressure type dispersion machine (MINI-LAB, manufactured by Larney Co., Ltd.) to obtain Colored aqueous liquid dispersion 1.

Synthesis of Binder Particulate Aqueous Liquid Dispersion

### Manufacturing Example 19

The following is placed in a 1,000 ml beaker equipped with a stirring device, a thermosensor, a nitrogen introducing tube and heated to 70° C. in a nitrogen atmosphere while stirring.

| | | |
|---|---|---|
| Distilled water | 480 | ml |
| Dodecyl sodium sulfate | 0.6 | g |
| Styrene | 106.4 | g |
| N-butyl acrylate | 43.2 | g |
| Methacrylate | 10.4 | g |

Initiator aqueous solution which 2.1 g of Potassium persulfate is dissolved in 120 ml of distilled water is added to the mixture followed by a 3-hour stirring in a nitrogen atmosphere at 70° C. to complete polymerization. Polymer binder particulate liquid dispersion 1 is obtained after cooling down to room temperature.

The following is placed in a 5,000 ml beaker equipped with a stirring device, a thermosensor, a nitrogen introducing tube and heated to 70° C. in a nitrogen atmosphere while stirring.

| | | |
|---|---|---|
| Distilled water | 2,400 | ml |
| Dodecyl sodium sulfate | 2.8 | g |
| Styrene | 620 | g |
| n-butyl acrylate | 128 | g |
| Methacrylate | 52 | g |
| tert-dodecyl mercaptane | 27.4 | g |

Initiator aqueous solution which 11.2 g of Potassium persulfate is dissolved in 600 ml of distilled water is added to the mixture followed by a 3-hour stirring in a nitrogen atmosphere at 70° C. to complete polymerization. Low molecular weight binder particulate liquid dispersion 2 is obtained after cooling down to room temperature.

### Comparative Example 1

Synthesis of Toner

The following is mixed and stirred in a 1,000 ml separable flask equipped with a stirrer, a condenser and a thermosensor and an aqueous solution of 5N-sodium hydroxide is used to adjust PH of the mixture to be 9.5.

| | | |
|---|---|---|
| Polymer binder particulate liquid dispersion 1 | 47.6 | g |
| Low molecular weight binder particulate liquid dispersion | 190.5 | g |
| Wax particle aqueous liquid dispersion | 17.7 | g |
| Colorant liquid dispersion 1 | 26.7 | g |
| Distilled water | 252.5 | ml |

Furthermore, an aqueous solution of sodium chloride in which 50 g of sodium chloride is dissolved in 600 ml of distilled water and an aqueous solution of surface active agent in which 77 ml of isopropanol and 10 mg of Fluorade FC-1700 (fluorine based nonion surface active agent, manufactured by [symbol] [symbol] 3M [symbol] [symbol] ) in 10 ml are sequentially added to the mixture while stirring. After heating the resultant to an inner temperature of 85° C. and a 6-hour reaction, the resultant is cooled down to room temperature. An aqueous solution of 5N-sodium hydroxide is used to adjust PH of the reaction solution to be 13 and the resultant is filtered. After repeating re-suspension of the resultant in distilled water and filtering the resultant, the resultant is dried after washing to obtain Comparative Toner 1 (volume average particle diameter (Dv): 6.52 μm, number average particle diameter (Dn): 5.31 μm, the ratio (Dv/Dn): 1.23)

### Comparative Example 2

Comparative Toner 2 is manufactured in the same manner as in Example 1 except that the laminar inorganic mineral is not added.

Comparative Toner 2 has a volume average particle diameter (Dv) of 5.60 μm, a number average particle diameter (Dn) of 4.14 μm and Dv/Dn is 1.35.

### Comparative Example 3

Comparative Toner 3 is manufactured in the same manner as in Example 3 except that paraffin wax is replaced with ethylene wax (melting point: 110° C., manufactured by Sanyo Chemical Industries Ltd.).

Comparative Toner 3 has a volume average particle diameter (Dv) of 5.65 μm, a number average particle diameter (Dn) of 4.51 μm and Dv/Dn is 1.25.

One hundred (100) parts of each toner obtained as described above is mixed with 0.7 parts of hydrophobic silica and 0.3 parts of hydrophbized titanium oxide by a HENSCHEL MIXER. The characteristics of the obtained toners are shown in Table 1.

A developing agent of a toner having 5% by weight and a copper-zinc ferrite carrier having 95% by weight the surface of which is covered with a silicone resin is prepared. The toner has been subject to external additive treatment. The carrier has an average particle diameter of 40 μm. These developing agents are tested according to each test method. The results are shown in Table 1.

TABLE 1

| | | | | | | Toner particle | | | | |
|---|---|---|---|---|---|---|---|---|---|---|
| | | Addition | Oil phase characteristics | | | diameter | | | | |
| | | amount | Non-Newtonian | Casson | | Volume | Number | | | |
| | | of | index | yield | Solid | average | average | | | |
| | | Clayton | tanθ | value | content | particle | particle | | | Heating |
| | Toner | APA | [−] | (Pa) | (%) | diameter | diameter | Dv/Dn | SF-1 | test |
| Example 1 | Toner 1 | 0.6 | 0.92 | 0.80 | 50 | 5.85 | 4.33 | 1.35 | 125 | 77 |
| Example 2 | Toner 2 | 1.6 | 0.85 | 2.60 | 50 | 5.65 | 5.09 | 1.11 | 131 | 78 |
| Example 3 | Toner 3 | 1.6 | 0.83 | 6.20 | 50 | 4.95 | 4.19 | 1.18 | 142 | 68 |
| Example 4 | Toner 4 | 1.6 | 0.88 | 1.90 | 50 | 5.60 | 4.96 | 1.13 | 135 | 69 |
| Example 5 | Toner 5 | 1.5 | 0.89 | 4.56 | 50 | 5.32 | 4.25 | 1.25 | 155 | 73 |
| Example 6 | Toner 6 | 1.5 | 0.72 | 16.60 | 50 | 5.95 | 5.04 | 1.18 | 170 | 71 |
| Example 7 | Toner 7 | 1.5 | 0.78 | 28.50 | 50 | 4.85 | 4.61 | 1.05 | 185 | 70 |
| Example 8 | Toner 8 | 1.5 | 0.95 | 0.60 | 50 | 3.65 | 3.11 | 1.17 | 115 | 66 |
| Example 9 | Toner 9 | 0.6 | 0.8 | 0.60 | 50 | 5.30 | 4.77 | 1.11 | 131 | 78 |
| Example 10 | Toner 10 | | | | | | | | | |
| Comparative | Comparative | | | | | 6.52 | 5.31 | 1.23 | 115 | 82 |
| Example 1 | Toner 1 | | | | | | | | | |
| Comparati | Comparati | 0.96 | 0.00 | 50.00 | 5.65 | 5.60 | 4.14 | 1.35 | 108 | 79 |

| | | | | | Low | | | | |
|---|---|---|---|---|---|---|---|---|---|
| | | Toner | | | molecular | | | | |
| | | | | Composition | weight | | Amount | | |
| | | | | ratio | Polyester | | of | High | |
| | | FL | Tg | (modified/ | Acid | | charge | temperature | Fine dot |
| | Toner | T½ | (° C.) | non-modified) | value | MW | (-μC/g) | preservability | representability |
| Example 1 | Toner 1 | 112.0 | 44.0 | 18.5/81.5 | 28.0 | 4500 | 20.5 | G | G |
| Example 2 | Toner 2 | 117.0 | 45.0 | 18.9/81.1 | 28.0 | 4500 | 36.5 | G | G |
| Example 3 | Toner 3 | 135.0 | 57.5 | 18.9/81.1 | 16.5 | 3900 | 37.0 | G | G |
| Example 4 | Toner 4 | 140.0 | 58.0 | 16.6/83.4 | 16.5 | 3900 | 34.5 | F | G |
| Example 5 | Toner 5 | 133.0 | 56.5 | 18.9/81.1 | 16.5 | 3900 | 35.0 | G | G |
| Example 6 | Toner 6 | 135.0 | 55.5 | 18.9/81.1 | 16.5 | 3900 | 31.5 | G | G |
| Example 7 | Toner 7 | 139.0 | 58.5 | 18.9/81.1 | 16.5 | 3900 | 35.5 | G | G |
| Example 8 | Toner 8 | 102.0 | 44.0 | 14.5/85.5 | 28.0 | 3900 | 20.5 | G | G |
| Example 9 | Toner 9 | 110.0 | 47.0 | 14.5/85.5 | 28.0 | 4500 | 21.5 | G | G |
| Example 10 | Toner 10 | | | | | | | | G |
| Comparative | Comparative | 118.0 | 62.0 | | 23.0 | 36000 | 21.0 | F | G |
| Example 1 | Toner 1 | | | | | | | | |
| Comparative | Comparative | 110.0 | 43.0 | 18.5/81.5 | 26.4 | 4500 | 12.5 | F | F |
| Example 2 | Toner 2 | | | | | | | | |
| Comparative | Comparative | 136.0 | 57.5 | 18.5/81.5 | 16.5 | 3900 | 34.0 | | F |
| Example 3 | Toner 3 | | | | | | | | |

| | | Image density | | | Background fouling | | | Cleaning | | |
|---|---|---|---|---|---|---|---|---|---|---|
| | Toner | Initial | 1,000th | 100,000th | Initial | 1,000th | 100,000th | Initial | 1,000th | 100,000th |
| Example 1 | Toner 1 | 1.25 | — | — | 0.02 | — | — | G | B | B |
| Example 2 | Toner 2 | 1.25 | 1.19 | 1.10 | 0.02 | 0.03 | 0.05 | G | G | G |
| Example 3 | Toner 3 | 1.35 | 1.28 | 1.20 | 0.02 | 0.05 | 0.05 | G | G | G |
| Example 4 | Toner 4 | 1.32 | 1.30 | 1.20 | 0.02 | 0.04 | 0.05 | G | G | G |
| Example 5 | Toner 5 | 1.29 | — | — | — | — | — | G | | |
| Example 6 | Toner 6 | 1.32 | — | — | — | — | — | G | | |
| Example 7 | Toner 7 | 1.25 | — | — | — | — | — | G | | |
| Example 8 | Toner 8 | 1.35 | 1.30 | 1.25 | 0.02 | 0.03 | 0.05 | G | B | B |
| Example 9 | Toner 9 | 1.30 | — | — | 0.02 | — | — | G | | |
| Example 10 | Toner 10 | 1.35 | 1.29 | 1.25 | 0.03 | 0.04 | 0.04 | G | G | G |
| Comparative | Comparative | 1.28 | — | — | 0.06 | — | — | G | B | B |
| Example 1 | Toner 1 | | | | | | | | | |
| Comparative | Comparative | 1.36 | — | — | 0.08 | — | — | G | B | B |
| Example 2 | Toner 2 | | | | | | | | | |
| Comparative | Comparative | 1.36 | — | — | 0.05 | — | — | G | G | |
| Example 3 | Toner 3 | | | | | | | | | |

FL (flow test) T1/2:

For example, a high elevated flow tester (CFT 500D type, manufactured by Shimadzu Corporation) can be used as a flow tester.

Flow curve by this flow tester is as shown in FIG. 4. Each temperature can be read from the graph in FIG. 4. In FIG. 4, Ts represents a softening temperature, Tfb represents flow starting temperature, and melting point is T1/2.

Measuring Condition

Load: 10 Kg/cm2, Rising temperature: 3.0° C./min

Die diameter: 0.50 mm, Die length: 1.0 mm, Starting temperature: 50° C., Reaching temperature: 250.0° C., preheating time: 200 S.

Sample Manufacturing Condition:

One (1.00 g) of the sample is molded to have a 10.0 mm by a molding device for the flow tester.

Evaluation Item

(a) Amount of Charge

The amount of charge is obtained by setting 6 g of a developing agent in a sealable metal cylinder for blow. The toner density is from 4.5 to 5.5% by weight.

(b) Fixing Property

Toner is tested using imagio Neo 450 (manufactured by Ricoh, Co., Ltd.) for solid image on plain (Type 6200, manufactured by Ricoh, Co., Ltd.) and thick (Photocopying paper <135>, manufactured by Ricoh, Co., Ltd.) transfer paper with a toner density of from 0.9 to 1.1 mg/cm². The temperature of a fixing belt can be variably adjusted. The temperature below which offset occurs is measured for the plain paper. The lowest fixing temperature is measured for the thick paper. The lower limit fixing temperature is determined as the fixing roll temperature below which the remaining ratio of the image density is less than 70% after the fixed image is rubbed by a pad.

(c) High Temperature Preservability

10.6 g of the toner is set in a 50 ml sample bottle followed by tapping for 35 seconds. The bottle is preserved in a constant temperature bath at 50° C. for 24 hours and the toner is measured by a penetrometer. The toner is evaluated by the value of the penetrometer at N=3.
Not greater than 10 mm: B (bad)
Greater than 10 mm to less than 15 mm: F (fair)
Not less than 15 mm: G (good)
   (d) Tg Measuring Method

The melting point and the glass transition temperature (Tg) of the releasing agent for use in the present invention can be measured by a Differential Scanning Calorimeter (DSC). The melting point of the wax can be determined by the peak top which indicates the maximum endothermic amount. The measuring is performed by TA-60WS (manufactured by Shimadzu Corporation) and DSC-60 under the following conditions:

Sample container: aluminum sample pan (with a lid)

Sample amount: 5 mg

Reference: aluminum sample pan (aluminum 10 mg)

Atmosphere: Nitrogen (flowing amount: 50 ml/min)

Temperature condition
Starting temperature: 20° C.
Temperature rising ratio: 10° C./min
Termination temperature: 150° C.
Held time None
Temperature descending ratio: 10° C./min
Termination temperature: 20° C.
Held time None
Temperature rising ratio: 10° C./min
Termination temperature: 150° C.

The measurement results are analyzed by data analysis software (TA-60, version 1.52, manufactured by Shimadzu Corporation). The peak temperature is obtained by the analysis method in which the peak analysis function of the analysis software is used with a range setting of from a temperature −5° C. lower than the maximum peak point of DrDSC curve which is DSC differential curve on the second temperature rise to +5° C. higher than the point. The obtained temperature corresponds to the melting point.

Tg of the resin is measured by the following method.

About 10 mg of a sample is set in an aluminum sample container. The container is set on a holder unit and the holder unit is set in an electric furnace. The sample is heated from room temperature to 150° C. at a temperature rising rate of 10° C./min and held at 150° C. for 10 minutes. After cooled down to room temperature, the sample is left for 10 minutes and heated again in a nitrogen atmosphere to 150° C. at a temperature rising rate of 10° C./min for DSC measurement. TG is analyzed by using TA-60 (version 1.52) and calculated by the intersectional point of the tangent of endothermic curve near Tg and the base line.

(e) Image Density

Toner is tested using imagio Neo 450 (manufactured by Ricoh, Co., Ltd.) for solid image on plain (Type 6200, manufactured by Ricoh, Co., Ltd.) and thick (Photocopying paper <135>, manufactured by Ricoh, Co., Ltd.) transfer paper. After outputting the solid image, the image density is measured by X-Rite (manufactured by X-Rite Incorporated). Five points are measured for each color and the average is measured therefor.

(f) Background Fouling

A white image is suspended in the middle of development and the developing agent on an image bearing member after development is transferred by a tape. The difference between the image density of the tape and that of a non-transferred tape is measured by 938 spectrodensitometer (manufactured by X-Rite Incorporated).

Not greater than 0.05 is minimally required to be good.

(g) Cleaning Property

Toner remaining after transfer on an image bearing member after cleaning process is transferred to white paper by a Scotch (manufactured by Sumitomo 3M). The white paper is measured by Macbeth reflection densitometer RD514 type. A difference between blank paper and the white paper that is not greater than 0.01 is evaluated as G (good) and that is greater than 0.01 is determined as B (bad).

(h) Dot Representation

A 600 dpi image is printed using imagio Neo 450 (optical system laser: 600 dpi, manufactured by Ricoh Co., ltd.) and observed by an optical microscope with a magnification power of 20× for the following 3 rank rating against sample for each rank: G (good), F (fair), B (bad).

(i) Molecular Weight Distribution Test Method

MW Distribution Measuring

Gel Permeation Chromatography (GPC) measuring method is described below. A column is stabilized in a heat chamber at 40° C. Tetrahydrofuran (THF) is used as a solvent and flown at a rate of 1 ml/min. A resin THF solution which is adjusted such that the sample density is 0.05 to 0.6% by weight is poured in an amount of 50 to 200 μl for measurement. With regard to the molecular weight of the sample, the molecular weight distribution of the sample is calculated by the relationship between the count number and the logarithm value of the analytical curve made based on several kinds of simple dispersion polystyrene standard sample. As the polystyrene standard samples for making analytical curve, for example, polystyrenes having a molecular weigh of 6×10², 2.1×10², 4×10², 1.75×10⁴, 5.1×10⁴, 1.1×10⁵, 3.9×10⁵, 8.6×10⁶, 2×10⁵ or 4.48×10⁶. At least 10⁶ polystyrene samples are desired to be used. A refraction index (RI) detector is used as the detector.

Weight average molecular weight (Mw), Number average molecular weight (Mn) and the ratio (Mw/Mn) are automatically calculated from the obtained values.

This document claims priority and contains subject matter related to Japanese Patent Application No. 2006-073720, filed on Mar. 17, 2006, the entire contents of which are incorporated herein by reference.

Having now fully described the invention, it will be apparent to one of ordinary skill in the art that many changes and modifications can be made thereto without departing from the spirit and scope of the invention as set forth therein.

What is claimed as new and desired to be secured by Letters Patent of the United States is:

1. A toner comprising a toner particle, said toner particle comprising:
a binder resin;
a colorant;
a releasing agent; and
a laminar inorganic mineral in which part or all ions present between layers therein are modified by organic ions,
wherein the toner particle is prepared by a method comprising dispersing or emulsifying a toner constituent liquid mixture comprising an organic solvent, the colorant, at least one member selected from the group consisting of the binder resin and a precursor of the binder resin, the releasing agent, and the laminar inorganic mineral, in an aqueous medium comprising water to obtain a liquid dispersion or an emulsion, and removing the organic solvent and water from the liquid dispersion or the emulsion,
said toner particle having a structure such that when the particle is heated at a temperature ranging from 65 to 90° C. the releasing agent is melted on the outside of the toner particle to form a particle having a sea-island structure.

2. The toner according to claim 1, wherein a volume average particle diameter of the toner is from 3 to 6 μm, a ratio (Dv/Dn) of a volume average particle diameter (Dv) to a number average particle diameter (Dn) it from 1.00 to 1.30, and the binder resin has a glass transition temperature (Tg) of from 40 to 55° C. and a weight average particle diameter (Mw) of from 3,000 to 6,500.

3. The toner according to claim 1, wherein the releasing agent has a melting point of from 65 to 80° C.

4. The toner according to claim 1, wherein the toner constituent liquid mixture comprises a polyester prepolymer comprising at least one isocyanate group and a compound for conducting an elongation reaction or cross-linking reaction with the prepolymer and the method further comprises conducting a cross-linking or elongation reaction in the toner constituent liquid mixture in the aqueous medium.

5. The toner according to claim 1, wherein a ratio of the releasing agent having a dispersion particle diameter of from 0.3 to 1.0 μm is not greater than 70% by number in the toner particle.

6. The toner according to claim 1, wherein the toner constituent liquid mixture has a Casson yield value of from 1 to 10 Pa at 25° C. and a non-Newtonian index tan θ of from 0.75 to 0.95 at 25° C. and the toner has a form factor SF-1 of from 140 to 200.

7. A method of manufacturing a toner particle comprising:
dispersing or emulsifying a toner constituent liquid mixture comprising an organic solvent, a colorant, at least one member selected from the group consisting of the binder resin and a precursor of the binder resin, a releasing agent and a laminar inorganic mineral in which part or all ions present between layers therein are modified by organic ions, in an aqueous medium comprising water to obtain a liquid dispersion or an emulsion; and
removing the organic solvent and water from the liquid dispersion or the emulsion,
said method producing a toner particle having a structure such that when the particle is heated at a temperature ranging from 65 to 90° C. the releasing agent is melted on the outside of the toner particle to form a particle having a sea-island structure.

8. The method of manufacturing a toner according to claim 7,
wherein the toner constituent liquid mixture has a non-Newtonian index tan θ of from 0.75 to 0.95 at 25° C.

9. The method of manufacturing a toner according to claim 7,
wherein the toner constituent liquid mixture has a Casson yield value of from 1 to 10 Pa at 25° C. and the toner particle has a form factor SF-1 of from 140 to 200.

10. A developing agent comprising:
the toner of claim 1; and
a carrier.

11. An image forming apparatus comprising:
an image bearing member configured to bear a latent image thereon;
a charging device configured to charge the image bearing member;
a developing device configured to develop the latent image comprising the toner of claim 1;
a transfer device configured to transfer the latent image to a transfer body;
a discharging device configured to discharge the image bearing member; and
a cleaning device configured to clean the surface of the image bearing member.

12. A method of forming an image comprising:
charging an image bearing member by a charging device;
irradiating the image bearing member by an irradiating device to form a latent electrostatic image thereon;
developing the latent electrostatic image on the image bearing member with the toner of claim 1;
removing residual toner remaining on the image bearing member by a cleaning device; and
transferring the toner image to a transfer body.

13. A toner container comprising a container and, therein, the toner of claim 1.

14. A process cartridge comprising;
an image bearing member configured to bear a latent electrostatic image;
a developing device configured to develop the latent electrostatic image comprising the toner of claim 1; and
at least one optional device selected from a group consisting of a cleaning device, a transfer device, an irradiating device and a charging device.
